(19) United States
(12) Patent Application Publication
(10) Pub. No.: US 2026/0355864 A1
(43) Pub. Date: Nov. 12, 2026

(54) METHOD OF JOINING STAINLESS STEEL AND COPPER OR COPPER ALLOY, AND JOINED BODY OF STAINLESS STEEL AND COPPER OR COPPER ALLOY AND METHOD OF PRODUCING SAME

(71) Applicant: JFE STEEL CORPORATION, Chiyoda-ku, Tokyo (JP)

(72) Inventors: Daiki HOSHI, Chiyoda-ku, Tokyo (JP); Shuji NISHIDA, Chiyoda-ku, Tokyo (JP)

(73) Assignee: JFE STEEL CORPORATION, Chiyoda-ku, Tokyo (JP)

(21) Appl. No.: 19/488,312

(22) PCT Filed: Apr. 5, 2024
(86) PCT No.: PCT/JP2024/014175

§ 371 Date: Nov. 26, 2025

(30) Foreign Application Priority Data
Jul. 3, 2023 (JP) 2023-109663
Jul. 27, 2023 (JP) 2023-122869

(51) Int. Cl. B23K 35/26; B23K 1/00; B23K 35/02; B23K 103/22; C22C 12/00; C22C 13/00; C22C 13/02; C22C 28/00

(52) U.S. Cl. CPC B23K 35/262; B23K 1/0012; B23K 35/0227; B23K 35/26; B23K 35/264; C22C 12/00; C22C 13/00; C22C 13/02; C22C 28/00; B23K 2103/22

(57) ABSTRACT

A low-cost, simple method of joining stainless steel and copper or copper alloy is provided, which can be carried out in air. The joining metal is Sn or Sn alloy having a Sn content of 40 mass % or more. In a joining process, the copper or copper alloy is heated by a heating device, and heat transfer from the copper or copper alloy causes the joining metal to be melted and the stainless steel to be heated, joining the stainless steel and the copper or copper alloy. A maximum arrival temperature of the stainless steel is 350 °C or lower. A residence time of the stainless steel in a temperature range of 150 °C or higher is 5 s or longer to 5 min or shorter.

### TECHNICAL FIELD

The present disclosure relates to a method of joining stainless steel and copper or copper alloy, and a joined body of stainless steel and copper or copper alloy and a method of producing same.

### BACKGROUND

Stainless steel is a material that has excellent corrosion resistance and is widely used in various heat exchangers for automobiles and air conditioners as steel sheets and steel pipes or tubes. Further, copper is a material that has excellent thermal conductivity and is widely used in various heat exchangers as copper sheets and copper pipes or tubes.

In recent years, with the rising price of copper, there has been a trend toward changing the material of copper and copper alloy heat exchangers to stainless steel instead of copper and copper alloy. However, changing all materials from copper and copper alloy to stainless steel is difficult, and some components made of copper and copper alloy remain. In such a case, a product is produced by combining stainless steel and copper or copper alloy components, and therefore stainless steel and copper or copper alloy must be joined.

### CITATION LIST

### Patent Literature

PTL 1: JP 2003-523830 A
PTL 2: JP 2005-349443 A

### SUMMARY

### Technical Problem

Brazing is often used in the production of heat exchangers as a method of joining components. The brazing methods used in the production of heat exchangers are mainly furnace brazing, in which members are heated in an atmospheric furnace to carry out multiple-point simultaneous joining, and torch brazing, in which a joining portion is heated with a torch in air to carry out single-point joining. From these brazing methods, an appropriate method is used depending on the product site and the assembly stage.

When brazing copper or copper alloys together, it is common to use phosphorus-copper filler as joining metal (brazing material). However, when phosphorus-copper filler is used as the joining metal for brazing stainless steel and copper or copper alloy, an embrittlement layer is formed at the interface between the stainless steel and the joining metal. As a result, the joining metal separates from the stainless steel, and a joined body of stainless steel and copper or copper alloy cannot be obtained.

Therefore, when brazing stainless steel and copper or copper alloy, silver filler is typically used as the joining metal. However, silver filler is expensive. Additionally, in torch brazing, which is carried out in air, the stainless steel is exposed to high temperature due to heating by the torch. This causes a thick oxide coating to form on the surface of the stainless steel, which inhibits the spreading of the brazing filler.

Further, PTL 1 describes:
“a method for making a joint between copper or copper alloys and austenitic steel alloys, in which method in between the junction surfaces of the objects to be joined together, there is arranged at least one intermediate layer, so that the junction surfaces including their intermediate layers are pressed together, and at least the junction area is heated in order to create a diffusion joint, characterized in that there is brought a first intermediate layer (3) on the junction surface of the steel object (2) or against said surface, mainly in order to prevent the nickel loss from the steel object (2), and at least a second intermediate layer (4) on the junction surface of the copper object (1) or against said surface in order to activate the creation of a diffusion joint.”

PTL 2 describes:
“a method of joining stainless steel and an object to be joined to the stainless steel, comprising: bringing a joining agent comprising solder and a joining metal into contact between the stainless steel and the object to be joined; and performing heat treatment while the joining agent is in contact with the stainless steel and the object to be joined.”

The technique described in PTL 1 provides an intermediate layer of nickel or the like between the joining surfaces of stainless steel and copper or copper alloy. Further, the technique described in PTL 2 provides a joining metal, specifically, nickel foil or nickel particles, in addition to solder, between the joining surfaces of stainless steel and copper or copper alloy. That is, both of the techniques of PTL 1 and 2 require the use of expensive nickel. Further, the increase in processing decreases productivity.

As described above, it cannot be said that a low-cost, simple method of joining stainless steel and copper or copper alloy that can be carried out in air has been developed. Therefore, there is a current demand for the development of such a method of joining stainless steel and copper or copper alloy.

In view of the current situation, it would be helpful to provide a method of joining stainless steel and copper or copper alloy that can be carried out in air, is low-cost, and is simple.

Further, it would be helpful to provide a joined body of stainless steel and copper or copper alloy, and a method of producing same.

### Solution to Problem

The inventors have conducted intensive studies and have arrived at the idea that when joining stainless steel and copper or copper alloy in air, it is desirable to use Sn and Sn alloy such as solder (hereinafter also referred to simply as Sn alloy) as the joining metal.

That is, one of the factors that makes brazing stainless steel and copper or copper alloy difficult is the formation of an oxide coating on the surface of the stainless steel. This oxide coating decreases the spreading of the joining metal. Further, in brazing, the component elements of the joining metal diffuse slightly at the interface between the base metals, forming a bond, and thereby joining. However, the oxide coating hinders the diffusion of the component elements of the joining metal.

Therefore, when brazing stainless steel and copper or copper alloy, it is necessary to suppress the formation of the oxide coating. Here, the higher the temperature, the more easily the oxide coating is formed. However, the melting point of Sn alloy is lower than that of silver filler and the like. Further, Sn alloy is advantageous in terms of cost. From the above, the inventors have arrived at the idea that when joining stainless steel and copper or copper alloy in air, it is desirable to use Sn alloy as the joining metal.

Based on the above ideas, the inventors used Sn alloy as the joining metal and joined stainless steel and copper or copper alloy under various conditions in air, and made the following discoveries.

(1) In torch brazing, when the material to be joined is overlapping stainless steel and copper or copper alloy, and the vicinity of a joining target (a copper end in FIG. 1 or a stainless steel end in FIG. 2) is heated with a torch, the temperature of the stainless steel increases more quickly than that of the copper or copper alloy in the heated region. Further, copper or copper alloy tends to diffuse heat to unheated regions. That is, copper or copper alloy has a higher thermal conductivity than stainless steel, and therefore the temperature increase occurs in the stainless steel more quickly than in the copper or copper alloy.

(2) Therefore, even when the temperature of the stainless steel is increased to at least the melting point of the joining metal (Sn alloy), the temperature of the copper remains less than the melting point of the joining metal. This results in a phenomenon in which the joining metal does not spread sufficiently.

(3) On the other hand, when the joining target is heated so that the temperature of the copper or copper alloy is at least the melting point of the joining metal, the stainless steel becomes even hotter. This causes a thick oxide coating to form on the surface of the stainless steel, causing the joining metal to separate from the stainless steel. Therefore, it has been difficult to join stainless steel and copper or copper alloy.

Based on the above discoveries, the inventors conducted further studies. As a result, the inventors have made the following discoveries.

By using Sn or Sn alloy having a Sn content of 40 mass % or more as the joining metal, and heating copper or copper alloy of the material to be joined, heat transfer from the copper or copper alloy causes the joining metal to be melted and the stainless steel to be heated. Further, in this case, a maximum arrival temperature of the stainless steel is controlled to 350 °C or lower, and a residence time of the stainless steel in a temperature range of 150 °C or higher is controlled to 5 s or longer and 5 min or shorter. This allows the joining metal to sufficiently spread, and also suppresses formation of a thick oxide coating on the surface of the stainless steel, thereby joining the stainless steel and copper or copper alloy.

Further, as another method, the inventors attempted to join stainless steel and copper or copper alloy by using a heating device that included a heater such as a soldering iron to heat and melt the joining metal, Sn alloy, instead of torch brazing. However, depending on the joining conditions, particularly the type of copper or copper alloy used for the material to be joined, there were cases where the Sn alloy did not spread sufficiently and the stainless steel and the copper or copper alloy were not joined. Further, there were cases where a thick oxide coating was formed on the surface of the stainless steel and the stainless steel and the copper or copper alloy were not joined.

Accordingly, the inventors conducted further experiments and studies and made the following discoveries.

It is important to appropriately control a heated position, particularly a contact position in a perpendicular-to-joining direction between the heater of the heating device and the material to be joined (hereinafter also referred to simply as the contact position), depending on the thermal conductivity of the copper or copper alloy used for the material to be joined. Specifically, it is important that when the contact position is defined relative to a reference position (0 mm) at an overlap end that is an initiation point for spreading the joining metal in-between overlapping surfaces of material to be joined, with the stainless steel side as +ve and the copper or copper alloy side as −ve:
when the thermal conductivity of the copper or copper alloy is 250 W/mK or more, a range of the contact position is from more than 0 mm to +15 mm, and
when the thermal conductivity of the copper or copper alloy is less than 250 W/mK, the range of the contact position is from −15 mm to +15 mm. Further, it is important to control a maximum arrival temperature of the stainless steel to 250 °C or lower and the residence time of the stainless steel in a temperature range of 100 °C or higher to 5 s or longer and 5 min or shorter. By simultaneously satisfying these conditions, the joining metal is sufficiently spread, and the formation of a thick oxide coating on the surface of the stainless steel is suppressed, thereby joining the stainless steel and the copper or copper alloy.

The present disclosure is based on these discoveries and further studies.

Primary features of the present disclosure are as follows.

1. A method of joining stainless steel and copper or copper alloy, the method comprising a joining process of joining material to be joined by using joining metal, the material to be joined being stainless steel and copper or copper alloy overlapped with each other, wherein
the joining metal is Sn or Sn alloy having a Sn content of 40 mass % or more, and
in the joining process:
   the copper or copper alloy is heated by a heating device, and heat transfer from the copper or copper alloy causes the joining metal to be melted and the stainless steel to be heated, joining the stainless steel and the copper or copper alloy,
   a maximum arrival temperature of the stainless steel is 350 °C or lower, and
   a residence time of the stainless steel in a temperature range of 150 °C or higher is 5 s or longer to 5 min or shorter.

2. The method of joining stainless steel and copper or copper alloy according to 1, above, wherein the heating device is a torch.

3. A method of joining stainless steel and copper or copper alloy, the method comprising a joining process of joining material to be joined by using joining metal, the material to be joined being stainless steel and copper or copper alloy overlapped with each other, wherein
the joining metal is Sn or Sn alloy having a Sn content of 40 mass % or more, and
in the joining process:
   a heating device including a heater is used, the heater is brought into contact with the material to be joined, thereby melting the joining metal and joining the stainless steel and the copper or copper alloy,
   a contact position between the heater and the material to be joined in a perpendicular-to-joining direction is defined relative to a reference position, 0 mm, at an overlap end that is an initiation point for spreading the joining metal in-between overlapping surfaces of the material to be joined, with the stainless steel side as +ve and the copper or copper alloy side as −ve:
      when the thermal conductivity of the copper or copper alloy is 250 W/mK or more, a range of the contact position is from more than 0 mm to +15 mm, and
      when the thermal conductivity of the copper or copper alloy is less than 250 W/mK, the range of the contact position is from −15 mm to +15 mm,
   a maximum arrival temperature of the stainless steel is 250 °C or lower, and
   a residence time of the stainless steel in a temperature range of 100 °C or higher is 5 s or longer to 5 min or shorter.

4. The method of joining stainless steel and copper or copper alloy according to 3, above, wherein the heating device is a soldering iron.

5. A joined body of stainless steel and copper or copper alloy, joined by the method of joining stainless steel and copper or copper alloy according to any one of 1 to 4, above.

6. A method of producing a joined body of stainless steel and copper or copper alloy, the method comprising joining stainless steel and copper or copper alloy by the method of joining stainless steel and copper or copper alloy according to any one of 1 to 4, above.

### Advantageous Effect

According to the present disclosure, a low-cost, simple method of joining stainless steel and copper or copper alloy that can be carried out in air is obtainable. Further, the joined body obtainable by using the joining method of the present disclosure can be produced at a lower cost than when silver brazing is used, and is therefore extremely advantageous when applied to joining target portions of stainless steel and copper or copper alloy of various equipment, such as gas water heaters and cold/hot water supply piping.

### BRIEF DESCRIPTION OF THE DRAWINGS

In the accompanying drawings:

FIG. 1 is a schematic diagram illustrating an example of a positional relationship in a joining method according to an embodiment of the present disclosure;

FIG. 2 is a schematic diagram illustrating an example of a positional relationship in a joining method according to an embodiment of the present disclosure;

FIG. 3 is a schematic diagram illustrating an example of a joined body according to an embodiment of the present disclosure;

FIG. 4 is a schematic diagram illustrating an example of a joined body according to an embodiment of the present disclosure;

FIG. 5 is an example of an optical micrograph of a joining portion cross-section of a joined body (an example of a joining portion cross-section for Test No. 1-2 of Example Group 1); and

FIG. 6 is an example of an optical micrograph of a joining portion cross-section of a joined body (an example of a joining portion cross-section for Test No. 3-2 of Example Group 3).

### DETAILED DESCRIPTION

The following describes embodiments of the present disclosure.

### [1] Method of Joining Stainless Steel and Copper or Copper Alloy

First, a method of joining stainless steel and copper or copper alloy (hereinafter also referred to simply as a joining method) according to an embodiment of the present disclosure is described.

The joining method according to a first embodiment includes:
a joining process of joining material to be joined by using joining metal, the material to be joined being stainless steel and copper or copper alloy overlapped with each other, wherein
the joining metal is Sn or Sn alloy having a Sn content of 40 mass % or more, and
in the joining process:
   the copper or copper alloy is heated by a heating device, and heat transfer from the copper or copper alloy causes the joining metal to be melted and the stainless steel to be heated, joining the stainless steel and the copper or copper alloy,
   a maximum arrival temperature of the stainless steel is 350 °C or lower, and
   a residence time of the stainless steel in a temperature range of 150 °C or higher is 5 s or longer to 5 min or shorter.

The joining method according to a second embodiment includes:
a joining process of joining material to be joined by using joining metal, the material to be joined being stainless steel and copper or copper alloy overlapped with each other, wherein
the joining metal is Sn or Sn alloy having a Sn content of 40 mass % or more, and
in the joining process:
   a heating device including a heater is used, the heater is brought into contact with the material to be joined, thereby melting the joining metal and joining the stainless steel and the copper or copper alloy,
   a contact position between the heater and the material to be joined in a perpendicular-to-joining direction is defined relative to a reference position, 0 mm, at an overlap end that is an initiation point for spreading the joining metal in-between overlapping surfaces of the material to be joined, with the stainless steel side as +ve and the copper or copper alloy side as −ve:
      when the thermal conductivity of the copper or copper alloy is 250 W/mK or more, a range of the contact position is from more than 0 mm to +15 mm, and
      when the thermal conductivity of the copper or copper alloy is less than 250 W/mK, the range of the contact position is from −15 mm to +15 mm,
   a maximum arrival temperature of the stainless steel is 250 °C or lower, and
   a residence time of the stainless steel in a temperature range of 100 °C or higher is 5 s or longer to 5 min or shorter.

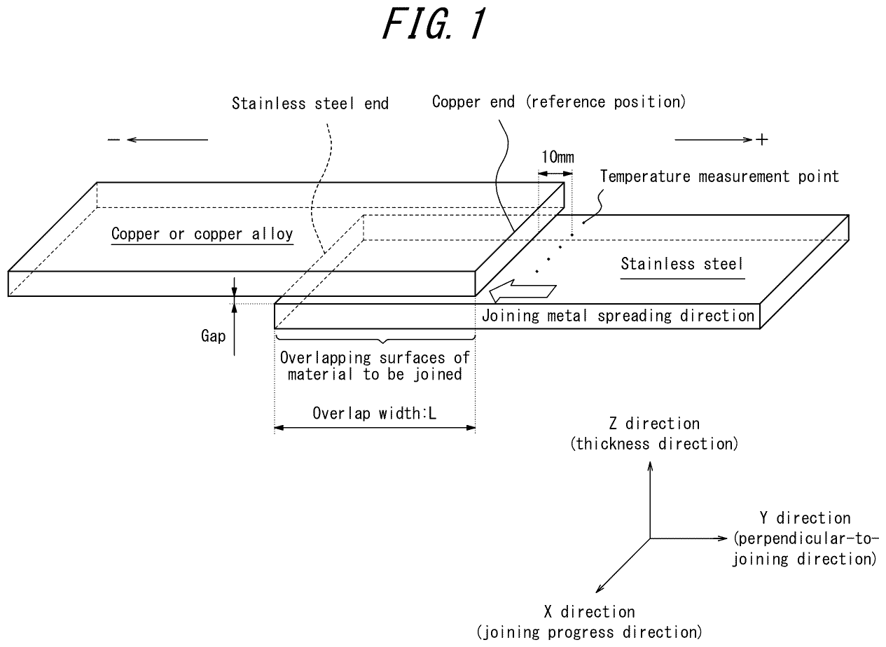

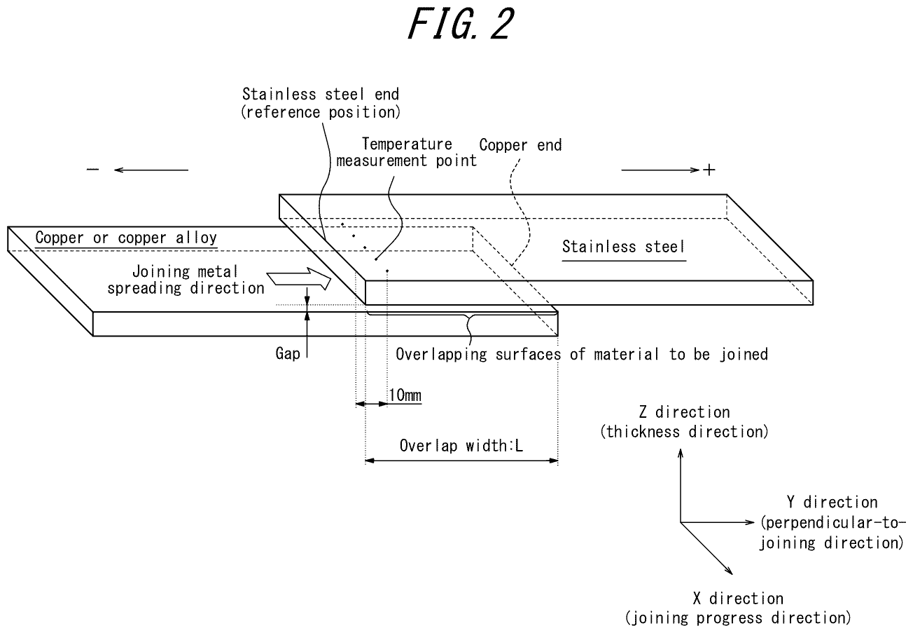

Here, when the initiation point of spreading the joining metal (in the perpendicular-to-joining direction) in-between the overlapping surfaces of the material to be joined is the copper or copper alloy end (hereinafter also referred to as the copper end) as illustrated in FIG. 1, the reference position is the copper end. When the initiation point of spreading the joining metal (in the perpendicular-to-joining direction) in-between the overlapping surfaces of the material to be joined is the stainless steel end as illustrated in FIG. 2, the reference position is the stainless steel end.

Further, in the joining method according to the second embodiment, as illustrated in FIG. 1, when the reference position is the copper end, the contact position is the surface of the material to be joined on which the copper or copper alloy is disposed (the upper surface of the material to be joined in FIG. 1, hereinafter also referred to as the copper-side surface of the material to be joined). As illustrated in FIG. 2, when the reference position is the stainless steel end, the contact position is the surface of the material to be joined on which the stainless steel is disposed (the upper surface of the material to be joined in FIG. 2, hereinafter also referred to as the stainless steel-side surface of the material to be joined).

In FIG. 1 to FIG. 6, X direction, Y direction, and Z direction are defined as follows.
X direction: joining progress direction
Y direction: perpendicular-to-joining direction (perpendicular to the joining progress direction (X direction) and perpendicular to a thickness direction (Z direction))
Z direction: the thickness direction of the material to be joined (joined body) (hereinafter also referred to simply as the thickness direction)

The joining method according to the first embodiment and the second embodiment is described in detail below. In the following description, when there is no particular specification as to whether the joining method is according to the first embodiment or the second embodiment, the description applies to the joining method according to both the first embodiment and the second embodiment.

### (1) Stainless Steel

Stainless steel is material to be joined (base metal of the joined body after joining), and the stainless steel is either a sheet shape (stainless steel sheet) or tubular (stainless steel pipe or tube). The sheet shape here includes curved sheets (bent sheets) as well as flat sheets. The stainless steel thickness (sheet thickness or tube thickness) is not particularly limited. From the viewpoint of heat transfer when joining, the stainless steel thickness is preferably 0.1 mm or more. Further, the stainless steel thickness is preferably 2.0 mm or less. The stainless steel thickness is more preferably 0.2 mm or more. The stainless steel thickness is even more preferably 0.3 mm or more. The stainless steel thickness is more preferably 1.0 mm or less.

When the stainless steel is in the shape of a sheet, the size of the sheet is not particularly limited. For example, from the viewpoint of heat dissipation after joining, the size is preferably 10 mm square or larger. The size is more preferably 30 mm square or larger.

When the stainless steel to be the base metal is tubular in shape, the size of the pipe or tube (outer diameter and length) is not particularly limited. For example, from the viewpoint of heat dissipation after joining, the outer diameter of the pipe or tube is preferably at least four times the tube thickness (wall thickness). Further, the outer diameter of the pipe or tube is preferably 5 mm or more. The outer diameter of the pipe or tube is preferably 500 mm or less. The length of the pipe or tube is preferably 10 mm or more. The length of the pipe or tube is more preferably 30 mm or more.

Further, the chemical composition of the stainless steel is not particularly limited and typical stainless steel composition suffices. For example, an iron alloy containing 10.5 mass % or more of Cr and 50 mass % or more of Fe. Examples include austenitic stainless steel sheets, austenitic-ferritic stainless steel sheets, ferritic stainless steel sheets, martensitic stainless steel sheets, precipitate-hardened stainless steel sheets, and processed products thereof, as defined in Japanese Industrial Standard JIS G 4305:2021. Further examples include stainless steel sanitary pipes, stainless steel tubes for ordinary piping, stainless steel pipes for piping, stainless steel tubes for boilers and heat exchangers, and processed products thereof, as defined in JIS G 3447:2015, JIS G 3448:2016, JIS G 3459:2021, JIS G 3463:2019, and JIS G 3468:2021. Stainless steel sheets that have various surface finishes may be used, such as No. 2B finish (annealed and pickled skin pass finish), No. 2D finish (annealed and pickled finish), No. 4 finish (polished finish), No. 8 finish (mirror polished finish), BA finish (bright annealed finish), HL (hairline) finish, dull finish, embossing finish, and blast finish.

### (2) Copper or Copper Alloy

Copper or copper alloy is material to be joined (base metal of the joined body after joining), and the copper or copper alloy is either a sheet shape (copper or copper alloy sheet) or tubular (copper or copper alloy pipe or tube). The sheet shape here includes curved sheets (bent sheets) as well as flat sheets. The copper or copper alloy thickness (sheet thickness or tube thickness) is not particularly limited. From the viewpoint of heat transfer when joining, the copper or copper alloy thickness is preferably 0.1 mm or more. The copper or copper alloy thickness is more preferably 0.3 mm or more. The copper or copper alloy thickness is even more preferably 0.5 mm or more. The copper or copper alloy thickness is preferably 4.0 mm or less. The copper or copper alloy thickness is more preferably 2.0 mm or less. The copper or copper alloy thickness is even more preferably 1.0 mm or less. In particular, in the joining method according to the second embodiment, from the viewpoint of suppressing inhibition of temperature increase of the material to be joined due to heat diffusion, the copper or copper alloy thickness is more preferably 2.0 mm or less. The copper or copper alloy thickness is even more preferably 1.0 mm or less.

When the copper or copper alloy is in the shape of a sheet, the size of the sheet is not particularly limited. For example, from the viewpoint of heat dissipation after joining, the size is preferably 10 mm square or larger. The size is more preferably 30 mm square or larger.

When the copper or copper alloy to be the base metal is tubular in shape, the size of the pipe or tube (outer diameter and length) is not particularly limited. For example, from the viewpoint of heat dissipation after joining, the outer diameter of the pipe or tube is preferably at least four times the tube thickness (wall thickness). Further, the outer diameter of the pipe or tube is preferably 5 mm or more. The outer diameter of the pipe or tube is preferably 500 mm or less. The length of the pipe or tube is preferably 10 mm or more. The length of the pipe or tube is more preferably 30 mm or more.

The copper or copper alloy referred to here includes not only so-called pure copper consisting of Cu and inevitable impurity, but also copper alloy containing 50 mass % or more of Cu. Examples include various copper or copper alloy sheets and pipes or tubes, including oxygen-free copper, tough-pitch copper, phosphorus-deoxidized copper, brass, free-cutting brass, and red brass, as well as processed products thereof, as defined in JIS H 3100:2018.

Further, copper alloy sheets and pipes or tubes such as phosphor bronze and nickel silver, as defined in JIS H 3110:2018, and processed products thereof can also be used. Here, for example, the thermal conductivity of oxygen-free copper and tough-pitch copper is 391 W/mK. The thermal conductivity of phosphorus-deoxidized copper is 339 W/mK to 381 W/mK. The thermal conductivity of brass and free-cutting brass is 117 W/mK to 121 W/mK. The thermal conductivity of red brass is 138 W/mK to 234 W/mK. The thermal conductivity of phosphor bronze is 58 W/mK to 201 W/mK. The thermal conductivity of nickel silver is 29 W/mK to 46 W/mK. In the case of a sheet, for example, copper sheets or copper alloy sheets having various surface finishes may be used, such as HL (hairline) finish, satin finish, blast finish, and hammered finish. Further, in the case of a pipe or tube, examples include copper or copper alloy seamless tubes and welded tubes, and processed products thereof, as defined in JIS H 3300:2018 and JIS H 3320:2006.

### (3) Joining Metal: Sn or Sn Alloy Having Sn Content of 40 Mass % or More

In order to suppress excessive temperature increase of the stainless steel during joining and to cause the joining metal to be sufficiently melted, the joining metal is Sn or Sn alloy that has a Sn content of 40 mass % or more. Here, when the Sn content of the joining metal is less than 40 mass %, the amount of heat required to melt the joining metal increases. This results in insufficient melting of the joining metal, and the stainless steel and the copper or copper alloy are not joined. Therefore, the joining metal is Sn or Sn alloy that has a Sn content of 40 mass % or more. The Sn content of the joining metal is preferably 90 mass % or more. Further, from the viewpoint of suppressing embrittlement in extremely cold regions, the Sn content of the joining metal is preferably 99.5 mass % or less. The Sn content of the joining metal is more preferably 97 mass % or less.

An example of Sn alloy having a Sn content of 40 mass % or more is solder. In particular, among the solders described in JIS Z 3282:2017, solder having a Sn content of 40 mass % or more may be suitably used. The joining metal may contain flux (so-called resin-cored solder may be used).

Examples of the Sn alloy are given below.

### (Sn—Ag Alloy)

Ag: 4.5 mass % to 5.5 mass %, with the balance being Sn and inevitable impurity.

### (Sn—Cu Alloy)

Cu: 2.0 mass % to 4.0 mass %, with the balance being Sn and inevitable impurity.

### (Sn—Sb Alloy)

Sb: 4.0 mass % to 6.0 mass %, with the balance being Sn and inevitable impurity.

### (Sn—Ag—Cu Alloy)

Ag: 0.5 mass % to 4.5 mass %, Cu: 0.2 mass % to 1.0 mass %, with the balance being Sn and inevitable impurity.

### (Sn—Pb Alloy)

Pb: 3.0 mass % to 60.0 mass %, with the balance being Sn and inevitable impurity.

### (Sn—Ag—Bi—Cu Alloy)

Ag: 2.0 mass % to 3.0 mass %, Bi: 0.5 mass % to 1.5 mass %, and Cu: 0.2 mass % to 1.0 mass %, with the balance being Sn and inevitable impurity.

### (Sn—In—Ag—Bi Alloy)

In: 3.0 mass % to 9.0 mass %, Ag: 3.0 mass % to 4.0 mass %, and Bi: 0.2 mass % to 1.0 mass %, with the balance being Sn and inevitable impurity.

### (Sn—Zn Alloy)

Zn: 8.0 mass % to 10.0 mass %, with the balance being Sn and inevitable impurity.

### (Sn—Zn—Bi Alloy)

Zn: 7.0 mass % to 9.0 mass %, Bi: 2.5 mass % to 3.5 mass %, with the balance being Sn and inevitable impurity.

### (Sn—Bi Alloy)

Bi: 55.0 mass % to 60.0 mass %, with the balance being Sn and inevitable impurity.

### (Sn—In Alloy)

In: 50.0 mass % to 55.0 mass %, with the balance being Sn and inevitable impurity.

Thus, the balance of the joining metal other than Sn is 60 mass % or less of metal elements such as Ag, Cu, Sb, Pb, Bi, In, and Zn (hereinafter also referred to as metal elements other than Sn). The content of the metal elements other than Sn is preferably 10 mass % or less. However, the metal elements other than Sn do not include Ni. The content of the metal elements other than Sn is preferably 0.5 mass % or more. The content of the metal elements other than Sn is more preferably 3.0 mass % or more. Suitable content of each of the metal elements other than Sn is, for example, Ag: 5.5 mass % or less, Cu: 4.0 mass % or less, Sb: 6.0 mass % or less, Pb: 60 mass % or less, Bi: 60 mass % or less, In: 55 mass % or less, and Zn: 10.0 mass % or less. More details are as described above.

Inevitable impurity included in the joining metal includes elements such as Pb, Sb, Bi, Cd, Cu, Au, In, Ag, Al, As, Cd, Fe, Ni, Zn, Ge, P, and Ga, and the total content of these elements is acceptable when 2.0 mass % or less. The amount of inevitable impurity may be 0 mass %. Elements that are intentionally added to the joining metal are not treated as inevitable impurity.

Further, the melting point of the joining metal is preferably 100 °C to 320 °C. Here, the melting point T (°C) of the joining metal is a temperature calculated from the solidus temperature Ts (°C) and liquidus temperature Tl (°C) of the joining metal by the following expression:

T=(Ts+Tl)/2

In particular, in the joining method according to the first embodiment, the melting point of the joining metal is preferably 100 °C or higher. The melting point of the joining metal is more preferably 190 °C or higher. Further, the melting point of the joining metal is preferably 320 °C or lower. The melting point of the joining metal is more preferably 300 °C or lower.

In the joining method according to the second embodiment, the melting point of the joining metal is preferably 100 °C or higher. The melting point of the joining metal is preferably 320 °C or lower. The melting point of the joining metal is more preferably 250 °C or lower. The melting point of the joining metal is even more preferably 240 °C or lower.

### (4) Joining Process

### (4-1) First Embodiment

In the joining process of the joining method according to the first embodiment, for example, while the heating device is moved in the joining progress direction, the material to be joined, which is overlapping stainless steel and copper or copper alloy (hereinafter, in the description of the joining process of the joining method according to the first embodiment and the second embodiment, copper and copper alloy is collectively referred to simply as copper), as illustrated in FIG. 1 or FIG. 2, is joined using the joining metal. At this time, the copper of the material to be joined is heated, and heat transfer from the copper causes the joining metal to be melted and the stainless steel to be heated, joining the stainless steel and the copper.

### Heated Location Heated by Heating Device: Copper

In the joining method according to the first embodiment, it is important that the copper of the material to be joined is heated using a heating device, and heat transfer from the copper causes the joining metal to be melted and the stainless steel to be heated, joining the stainless steel and the copper. This allows the joining metal to sufficiently spread, and also suppresses formation of a thick oxide coating on the surface of the stainless steel, thereby joining the stainless steel and the copper. Therefore, of the material to be joined, the location heated by the heating device (hereinafter referred to simply as the heated location) is copper. In the description of the heated location, and in the EXAMPLES section below, copper and copper alloy is collectively referred to simply as copper.

Here, the heated location being copper means the following.

(Joining Condition 1-a) As illustrated in FIG. 1, when the joining target is a copper end vicinity (the initiation point for spreading the joining metal in-between the overlapping surfaces of the material to be joined is at the copper end or, in other words, the supply position of the joining metal is the copper end side of the material to be joined) and the region heated by the heating device (for example, in the case of a torch, the region that the gas flame comes into contact with, hereinafter referred to simply as the heated region) is a top surface of the copper (the surface of the copper opposite to the side that overlaps with the stainless steel)

Here, “the heated location is copper” means that in the perpendicular-to-joining direction, when the copper end is the reference position (0 mm), the stainless steel side is +ve, and the copper side is −ve, the heated position is at less than 0 mm and stainless steel is not included in the heated region.

(Joining Condition 1-b) As illustrated in FIG. 1, when the joining target is the copper end vicinity and the heated region heated by the heating device is a bottom surface of the copper (the surface of the copper that overlaps with the stainless steel)

Here, “the heated location is copper” means that in the perpendicular-to-joining direction, when the copper end is the reference position (0 mm), the stainless steel side is +ve, and the copper side is −ve, the heated position is at less than −L (overlap width) mm and stainless steel is not included in the heated region.

(Joining Condition 2-a) As illustrated in FIG. 2, when the joining target is a stainless steel end vicinity (the initiation point for spreading the joining metal in-between the overlapping surfaces of the material to be joined is at the stainless steel end or, in other words, the supply position of the joining metal is the stainless steel end side of the material to be joined) and the heated region is the top surface of the copper (the surface of the copper on the side overlapping with the stainless steel)

Here, “the heated location is copper” means that in the perpendicular-to-joining direction, when the stainless steel end is the reference position (0 mm), the stainless steel side is +ve, and the copper side is −ve, the heated position is at less than 0 mm and stainless steel is not included in the heated region.

(Joining Condition 2-b) As illustrated in FIG. 2, when the joining target is the stainless steel end vicinity and the heated region is the bottom surface of the copper (the surface of the copper opposite to the side that overlaps with the stainless steel)

Here, “the heated location is copper” means that in the perpendicular-to-joining direction, when the stainless steel end is the reference position (0 mm), the stainless steel side is +ve, and the copper side is −ve, the heated position is at less than L (overlap width) mm and stainless steel is not included in the heated region.

The heated position here refers to a center position of the heated region in the perpendicular-to-joining direction.

Further, from the viewpoint of more reliably excluding the stainless steel from the heated region and sufficiently melting the joining metal while heating the stainless steel by heat transfer from the copper, according to the above joining conditions, it is preferable to set the heated position in the perpendicular-to-joining direction as follows.

### (Joining Condition 1-a)

The copper end is the reference position (0 mm) and the range is −(L+100) mm to −L mm on the top surface of the copper

### (Joining Condition 1-b)

The copper end is the reference position (0 mm) and the range is −(L+100) mm to −(L+10) mm on the bottom surface of the copper

### (Joining Condition 2-a)

The stainless steel end is the reference position (0 mm) and the range is −100 mm to −10 mm on the top surface of the copper

### (Joining Condition 2-b)

The stainless steel end is the reference position (0 mm) and the range is −100 mm to 0 mm on the bottom surface of the copper

### Maximum Arrival Temperature of Stainless Steel: 350 °C or Lower

In the joining method according to the first embodiment, it is important to suppress the formation of an oxide coating on the surface of the stainless steel. In particular, when heating with a torch or the like, when the maximum arrival temperature of the stainless steel during joining exceeds 350 °C, an oxide coating is rapidly formed on the surface of the stainless steel, causing the joining metal to separate from the stainless steel. The maximum arrival temperature of the stainless steel is therefore 350 °C or lower. The maximum arrival temperature of the stainless steel is preferably 300 °C or lower. There is no particular lower limit to the maximum arrival temperature of the stainless steel. The maximum arrival temperature of the stainless steel is, for example, preferably 200 °C or higher. The maximum arrival temperature of the stainless steel is more preferably 250 °C or higher.

### Residence Time of Stainless Steel in Temperature Range of 150 °C or Higher (Hereinafter Also Referred to as Residence Time of Stainless Steel at 150 °C or Higher): 5 s or Longer and 5 Min or Shorter

In the joining method according to the first embodiment, as described above, of the material to be joined, copper is heated. Heat transfer from the copper then causes the stainless steel to be heated and the joining metal to be melted, and the joining metal flows in-between the overlapping surfaces of the material to be joined. Further, at this time, excessive temperature increase of the stainless steel is suppressed, and the formation of an oxide coating on the surface of the stainless steel is suppressed. When the residence time of the stainless steel at 150 °C or higher is shorter than 5 s, the joining metal does not flow sufficiently in-between the overlapping surfaces of the material to be joined, hindering the joining of the stainless steel and the copper. On the other hand, when the residence time of the stainless steel at 150 °C or higher is longer than 5 min, a thick oxide coating forms on the surface of the stainless steel, hindering the joining of the stainless steel and the copper. The residence time of the stainless steel at 150 °C or higher is therefore 5 s or longer and 5 min (300 s) or shorter. The residence time of the stainless steel at 150 °C or higher is preferably 15 s or longer. The residence time of the stainless steel at 150 °C or higher is preferably 3 min (180 s) or shorter. The residence time of the stainless steel at 150 °C or higher is more preferably 1 min (60 s) or shorter.

In measuring the temperature of the stainless steel to derive the maximum arrival temperature of the stainless steel and the residence time at 150 °C or higher, an entire surface of the stainless steel may be measured by thermography, for example. Further, depending on the heated region heated by the heating device, the surface temperature of the stainless steel in a heated region vicinity may be measured using a thermocouple.

For example, in the case of (Joining Condition 1-a) and (Joining Condition 1-b), the copper end is the reference position (0 mm), and the surface temperature of a first surface of the stainless steel (the upper surface of the stainless steel in FIG. 1) may be measured at a position from 0 mm (copper end) to +20 mm in the perpendicular-to-joining direction. Further, in the case of (Joining Condition 2-a) and (Joining Condition 2-b), the stainless steel end is the reference position (0 mm), and the surface temperature of a second surface of the stainless steel (the upper surface of the stainless steel in FIG. 2) may be measured at a position from 0 mm (stainless steel end) to +20 mm in the perpendicular-to-joining direction.

At the above positions, the temperature of the stainless steel is approximately the same during joining, and therefore the temperature measurement position may be determined from the above positions depending on the structure of the material to be joined and the like. Here, the first surface of the stainless steel is the surface of the stainless steel on the side that overlaps with the copper (where the copper is placed), and the second side of the stainless steel is the surface of the stainless steel opposite to the side that overlaps with the copper. A measurement interval for the temperature of the stainless steel in the joining progress direction is preferably 3 mm to 10 mm, for example.

The maximum arrival temperature of the stainless steel during joining and the residence time of the stainless steel at 150 °C or higher can be controlled by adjusting, in addition to the heated position, for example, joining speed (moving speed of the heating device in the joining progress direction), a distance between the heating device and the material to be joined, and an output of the heating device. For example, when a torch is used as the heating device, the maximum arrival temperature of the stainless steel during joining and the residence time of the stainless steel at 150 °C or higher can be controlled in the ranges described above by adjusting the joining speed in a range from 30 mm/min to 200 mm/min, the distance between the heating device and the material to be joined in a range from 50 mm to 150 mm, and the output of the heating device in a range from 2000 kcal/h to 3000 kcal/h, depending on the type, size, and arrangement of the material to be joined.

Further, the heating device is not particularly limited as long as the heating device can cause the stainless steel to be heated and the joining metal to be melted by heat transfer from the copper, as described above, and can control the maximum arrival temperature and the residence time of the stainless steel during joining in the ranges described above. The heating device is preferably a torch (for example, a heating device specified in JIS Z 3001-1:2018), particularly a torch that uses a gas flame (torch burner).

The size of the heated region is not particularly limited. To ensure that stainless steel is excluded from the heated region, the heated region is preferably contained in a 30 mm square. For example, a torch having a nozzle diameter of 10 mm to 20 mm may be used.

### (4-2) Second Embodiment

In the joining process of the joining method according to the second embodiment, for example, while moving the heating device in the joining progress direction, the heater of the heating device is brought into contact with the material to be joined, which is overlapping stainless steel and copper as illustrated in FIG. 1 or FIG. 2. This melts the joining metal and joins the stainless steel and the copper. At this time, it is important to appropriately control the contact position depending on the thermal conductivity of the copper used in the material to be joined.

Contact Position when Thermal Conductivity of Copper is 250 W/mK or More: More than 0 mm to +15 mm

When the thermal conductivity of the copper is 250 W/mK or more, and the contact position is 0 mm or less, in other words the contact position is copper, much of the heat input from the heater of the heating device is conducted in the copper, and the stainless steel is not heated sufficiently. As a result, the joining metal does not flow sufficiently in-between the overlapping surfaces of the material to be joined, hindering the joining of the stainless steel and the copper. On the other hand, when the contact position exceeds +15 mm, the joining metal and the stainless steel in the vicinity of the overlapping surfaces of the material to be joined are not heated sufficiently. As a result, the joining metal does not flow sufficiently in-between the overlapping surfaces of the material to be joined, hindering the joining of the stainless steel and the copper. Therefore, when the thermal conductivity of the copper is 250 W/mK or more, the contact position is in the range of more than 0 mm to +15 mm. The contact position is preferably +1 mm or more. Further, the contact position is more preferably +10 mm or less. The contact position is even more preferably +5 mm or less.

Contact Position when Thermal Conductivity of Copper is Less than 250 W/mK: −15 mm to +15 mm

When the thermal conductivity of the copper is less than 250 W/mK, the stainless steel can be heated sufficiently even when the contact position is copper. However, when the contact position is less than −15 mm, the stainless steel is not heated sufficiently. As a result, the joining metal does not flow sufficiently in-between the overlapping surfaces of the material to be joined, hindering the joining of the stainless steel and the copper. On the other hand, when the contact position exceeds +15 mm, the stainless steel in the vicinity of the overlapping surfaces of the material to be joined is not heated sufficiently. As a result, the joining metal does not flow sufficiently in-between the overlapping surfaces of the material to be joined, hindering the joining of the stainless steel and the copper. Therefore, when the thermal conductivity of the copper is less than 250 W/mK, the contact position is in the range from −15 mm to +15 mm. The contact position is preferably −5 mm or more. Further, the contact position is more preferably +5 mm or less.

As mentioned above, the contact position is indicated relative to a reference position (0 mm) at an overlap end that is an initiation point for spreading the joining metal in-between overlapping surfaces of material to be joined, with the stainless steel side as +ve and the copper side as −ve. Further, when the reference position is the copper end, the contact position is the copper side surface of the material to be joined. Further, when the reference position is the stainless steel end, the contact position is the stainless steel side surface of the material to be joined.

For example, as illustrated in FIG. 1, when the initiation point for spreading the joining metal in-between the overlapping surfaces of the material to be joined is at the copper end, in other words, when the supply position of the joining metal is on the copper end side of the material to be joined, the reference position is the copper end of the material to be joined. In this case, the contact position is the copper side surface of the material to be joined (the upper surface of the material to be joined in FIG. 1).

Further, as illustrated in FIG. 2, when the initiation point for spreading the joining metal in-between the overlapping surfaces of the material to be joined is at the stainless steel end, in other words, when the supply position of the joining metal is on the stainless steel end side of the material to be joined, the reference position is the stainless steel end. In this case, the contact position is the stainless steel side surface of the material to be joined (the upper surface of the material to be joined in FIG. 2).

The contact position here refers to the center position in the perpendicular-to-joining direction of the region where the heater of the heating device and the material to be joined come into contact.

Further, the joining metal can be melted by heat transfer from the material to be joined, and therefore the heater of the heating device may or may not come into contact with the joining metal. The heater of the heating device may be in contact with the end face of the overlapping portion of the material to be joined on the reference position side.

### Maximum Arrival Temperature of Stainless Steel: 250 °C or Lower

In the joining method according to the second embodiment, it is important to suppress the formation of an oxide coating on the surface of the stainless steel. In particular, when joining by the heating method described above, when the maximum arrival temperature of the stainless steel exceeds 250 °C, an oxide coating is rapidly formed on the surface of the stainless steel, causing the joining metal to separate from the stainless steel. The maximum arrival temperature of the stainless steel is therefore 250 °C or lower. There is no particular lower limit to the maximum arrival temperature of the stainless steel. The maximum arrival temperature of the stainless steel is, for example, preferably 150 °C or higher. The maximum arrival temperature of the stainless steel is more preferably 200 °C or higher.

### Residence Time of Stainless Steel in Temperature Range of 100 °C or Higher (Hereinafter Also Referred to as Residence Time of Stainless Steel at 100 °C or Higher): 5 s or Longer and 5 Min or Shorter

In the joining method according to the second embodiment, as described above, the heating device including the heater is used, and the heater is brought into contact with the material to be joined for heating. This causes the joining metal to flow in-between the overlapping surfaces of the material to be joined. Further, at this time, excessive temperature increase of the stainless steel is suppressed, and the formation of an oxide coating on the surface of the stainless steel is suppressed. When the residence time of the stainless steel at 100 °C or higher is shorter than 5 s, the joining metal does not flow sufficiently in-between the overlapping surfaces of the material to be joined, hindering the joining of the stainless steel and the copper. On the other hand, when the residence time of the stainless steel at 100 °C or higher is longer than 5 min, a thick oxide coating forms on the surface of the stainless steel, hindering the joining of the stainless steel and the copper. The residence time of the stainless steel at 100 °C or higher is therefore 5 s or longer and 5 min (300 s) or shorter. The residence time of the stainless steel at 100 °C or higher is preferably 15 s or longer. The residence time of the stainless steel at 100 °C or higher is preferably 3 min (180 s) or shorter. The residence time of the stainless steel at 100 °C or higher is more preferably 1 min (60 s) or shorter.

In measuring the temperature of the stainless steel to derive the maximum arrival temperature of the stainless steel and the residence time of the stainless steel at 100 °C or higher, an entire surface of the stainless steel may be measured by thermography, for example. Further, depending on the heated region (contact region between the heater of the heating device and the material to be joined) heated by the heating device, the surface temperature of the stainless steel in the heated region vicinity may be measured using a thermocouple.

For example, when the initiation point for spreading the joining metal in-between the overlapping surfaces of the material to be joined is the copper end as illustrated in FIG. 1, the copper end is the reference position (0 mm), and the surface temperature of the first surface of the stainless steel (the upper surface of the stainless steel in FIG. 1) may be measured at a position from 0 mm (copper end) to +20 mm in the perpendicular-to-joining direction. Further, when the initiation point for spreading the joining metal in-between the overlapping surfaces of the material to be joined is the stainless steel end as illustrated in FIG. 2, the stainless steel end is set as the reference position (0 mm), and the surface temperature of the second surface of the stainless steel (the upper surface of the stainless steel in FIG. 2) may be measured at a position from 0 mm (the stainless steel end) to +20 mm in the perpendicular-to-joining direction. Further, in this case, the surface temperature of the end face of the stainless steel may be measured.

At the above positions, the temperature of the stainless steel is approximately the same during joining, and therefore the temperature measurement position may be determined from the above positions depending on the structure of the material to be joined and the like. Here, the first surface of the stainless steel is the surface of the stainless steel on the side that overlaps with the copper (where the copper is placed), and the second side of the stainless steel is the surface of the stainless steel opposite to the side that overlaps with the copper. The measurement interval for the temperature of the stainless steel in the joining progress direction is preferably 3 mm to 10 mm, for example.

The maximum arrival temperature of the stainless steel during joining and the residence time of the stainless steel at 100 °C or higher can be controlled by adjusting, for example, the joining speed (the moving speed of the heating device in the joining progress direction) and the output of the heating device in addition to the contact region between the heater of the heating device and the material to be joined. For example, when a soldering iron is used as the heating device, the maximum arrival temperature of the stainless steel during joining and the residence time of the stainless steel at 100 °C or higher can be controlled in the ranges described above by adjusting the joining speed in the range from 30 mm/min to 200 mm/min and the output (heat amount) of the heating device in the range from 100 W to 500 W, depending on the type, size, and arrangement of the material to be joined.

Further, the heating device is not particularly limited as long as it includes the heater as described above and can heat the material to be joined by bringing the heater into contact with the material to be joined. An example of such a heating device is a soldering iron. The heat generating method of the heater can be, for example, an electric type (powered or battery type) or a gas type. Further, the output (heat amount) of the heating device is preferably 100 W or more. That is, when the amount of heat generated is small, it takes a long time for the temperature of the material to be joined to increase, which may lead to the formation of an oxide coating on the surface of the stainless steel. Further, a tip diameter of the heater (in the case of a soldering iron, the tip diameter of the soldering iron tip) is preferably 1 mm to 5 mm. Further, when the surface of the heater is oxidized due to its own heat generation, the surface is preferably polished with a metal file or the like to remove oxides before starting joining.

Conditions other than those described above are not particularly limited in the joining method according to the first embodiment and the second embodiment, and may be in accordance with conventional methods.

For example, the joining metal may be applied or placed between the overlapping surfaces of the material to be joined, at the copper end or the stainless steel end, before heating. Further, the joining metal may be continuously supplied to the material to be joined during joining (by inserting a filler rod to the material to be joined). In particular, it is preferable to place the joining metal on the copper end or stainless steel end of the material to be joined before heating.

Further, the overlap width L (width in the perpendicular-to-joining direction) of the stainless steel and copper is preferably, for example, 5 mm to 20 mm. The gap between the overlapping portions of the stainless steel and the copper (the distance between the stainless steel and the copper, hereinafter also referred to simply as the gap) is preferably, for example, 0.01 mm to 0.50 mm.

Further, the maximum arrival temperature of the copper during joining, from the viewpoint of avoiding a decrease in the strength and corrosion resistance of copper, for example, is preferably 500 °C or less. The maximum arrival temperature of the copper during joining is more preferably 350 °C or less. Further, from the viewpoint of avoiding softening of copper, the residence time of the copper in a temperature range of 200 °C or higher is, for example, preferably 5 min or shorter. The residence time of the copper in the temperature range of 200 °C or higher is more preferably 3 min or shorter.

In addition, from the viewpoint of improving the spreading of the joining metal and improving workability, it is preferable to apply flux to the joining target of the material to be joined and the vicinity before the joining process. As the flux, a typical flux for stainless steel is suitable. For example, it is preferable to use an aqueous solution containing zinc chloride: 30 mass % to 50 mass %, ammonium chloride: 1 mass % to 10 mass %, hydrogen chloride: 1 mass % to 10 mass %, water: 30 mass % to 70 mass %, with the balance being inevitable impurity. The flux may be applied to the joining target and the vicinity of both the stainless steel and the copper of the material to be joined, or may be applied to the joining target and the vicinity of only the stainless steel or the copper. Further, the flux may be applied to only the joining target, or to only a portion of the joining target.

### [2] Joined Body of Stainless Steel and Copper or Copper Alloy

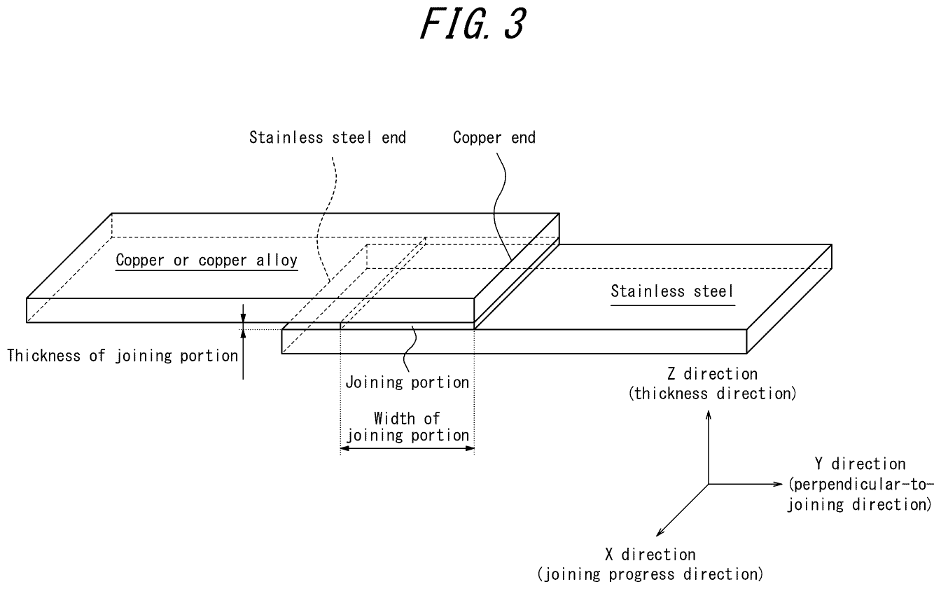

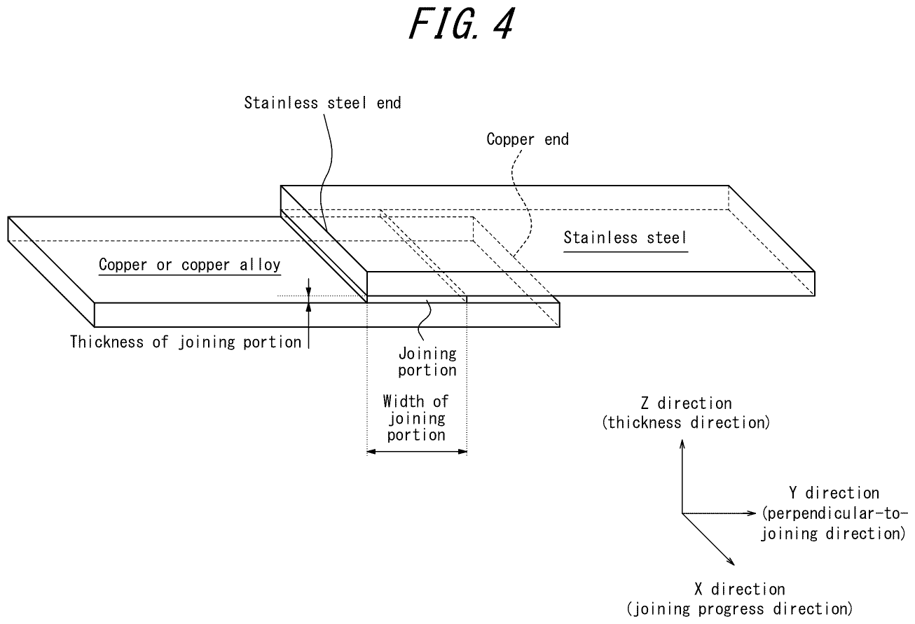

The joined body of stainless steel and copper or copper alloy according to an embodiment of the present disclosure (hereinafter also referred to simply as the joined body) includes stainless steel, copper or copper alloy, and a joining portion joining the stainless steel and the copper or copper alloy, as illustrated in FIG. 3 or FIG. 4. Further, the joining portion is located between the stainless steel and the copper or copper alloy at the overlapping portion where the stainless steel and the copper or copper alloy overlap each other. Such a joined body can be suitably obtained, for example, by the joining method described under [1], above.

The stainless steel and the copper or copper alloy of the joined body are derived from the stainless steel and the copper or copper alloy of the material to be joined, as explained under [1], above.

The Sn content of the joining portion is preferably 40 mass % or more. The Sn content of the joining portion is more preferably 90 mass % or more. The Sn content of the joining portion is preferably 99.5 mass % or less. The Sn content of the joining portion is more preferably 97 mass % or less. The balance may contain non-metallic particles such as oxides. The metal elements other than Sn and inevitable impurity are the same as the metal elements described under (3) Joining metal under [1], above, and therefore description is omitted here.

Further, an average thickness of the joining portion is preferably 0.50 mm or less. The average thickness of the joining portion is more preferably 0.20 mm or less. Further, the average thickness of the joining portion is preferably 0.01 mm or more. The average thickness of the joining portion is more preferably 0.02 mm or more.

An average width of the joining portion (average length of the joining portion in the perpendicular-to-joining direction) is preferably 1.0 mm or more. The average width of the joining portion is more preferably 2.0 mm or more. The average width of the joining portion is even more preferably 5.0 mm or more.

When the initiation point for spreading the joining metal in-between the overlapping surfaces of the material to be joined is at the copper end side as illustrated in FIG. 1, a joined body is obtainable in which the joining portion is in contact with the copper end as illustrated in FIG. 3, for example. Further, when the initiation point for spreading the joining metal in-between the overlapping surfaces of the material to be joined is on the stainless steel end side as illustrated in FIG. 2, a joined body is obtainable in which the joining portion is in contact with the stainless steel end as illustrated in FIG. 4. The joining portion may be in contact with both the copper end and the stainless steel end. Further, the width of the joining portion may be equal to the overlap width L.

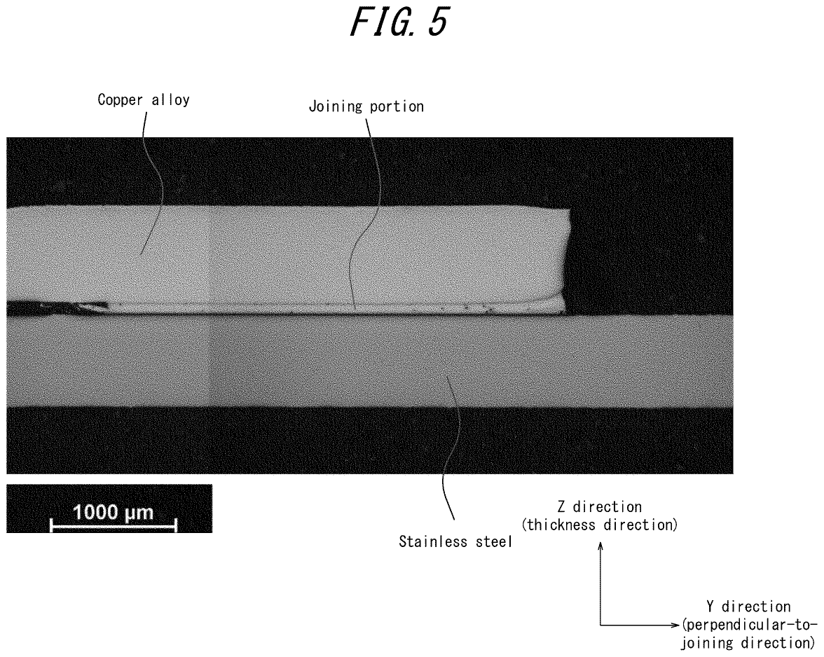

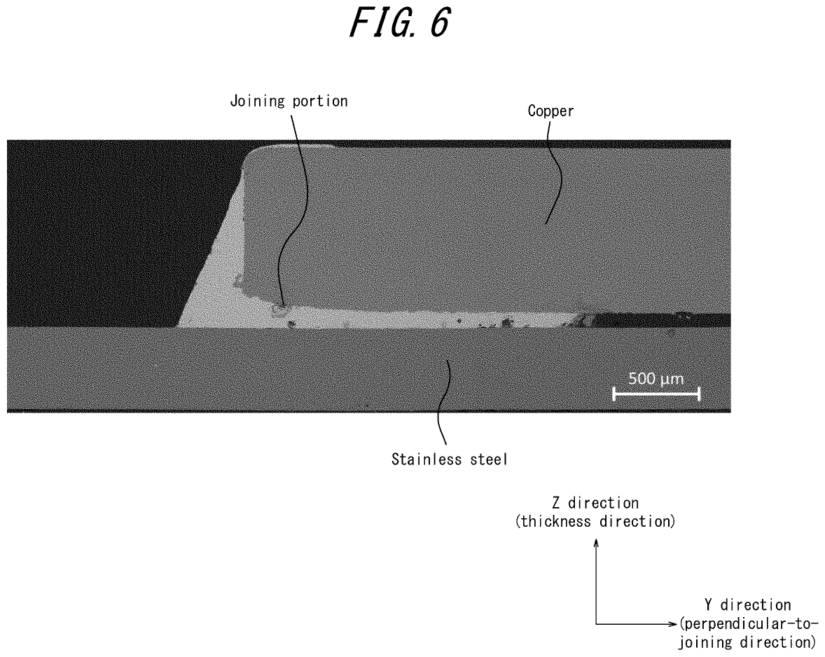

Here, the joining portion is defined, for example, as follows. First, a cross-section sample in the thickness direction of the joining portion (a sample having a cross-section in a plane (YZ plane) perpendicular to the joining progress direction (X direction)) as illustrated in FIG. 5 and FIG. 6 is prepared and finished with mirror polishing. Next, the cross-section sample is observed with an optical microscope or SEM at a magnification of 100 times. Then, based on the difference in color tone (contrast) of each microstructure and the contrast of the interface observed in an obtained image, the interface between the joining portion and the stainless steel (base metal) and the interface between the joining portion and the copper or copper alloy (base metal) are determined, and the joining portion is defined. Then, based on the defined joining portion, the thickness and the width of the joining portion in the cross-section sample are measured. This measurement is carried out on four cross-section samples cut out at random from the joined body, and the thickness and the width of the joining portion of each cross-section sample are determined. Next, average values are calculated and used as the thickness and the width of the joining portion of the joined body.

In the cross-section sample, when the thickness of the joining portion is not uniform, such as when there are portions that are not parallel to the interface between the joining portion and the stainless steel or the interface between the joining portion and the copper or copper alloy, the thickness of the joining portion in the cross-section is calculated as follows. The thickness of the joining portion defined as above is measured at five equally spaced locations, including both ends. An average value of the thickness of the joining portion measured at the five locations is then taken as the thickness of the joining portion of the cross-section.

Further, the Sn content of the joining portion is measured at a ½ thickness position of the joining portion. For example, the Sn content of the joining portion may be measured as follows.

First, a cross-section sample in the thickness direction (a sample having a cross-section in a plane (YZ plane) perpendicular to the X direction, which is the joining progress direction), as illustrated in FIG. 5 and FIG. 6, is prepared. At this time, the cross-section is mirror-polished and then etched using an etching solution (5 mL of 38 mass % aqueous solution of iron(II) chloride-15 mL of 36 mass % hydrochloric acid-120 mL of distilled water). Next, the cross-section sample is observed by SEM at a magnification of 100 times, and then subjected to SEM-EDS analysis. In this analysis, an EDS point scan is carried out on the joining portion of the cross-section to measure the Sn content (mass %). The EDS scan points are 10 points randomly selected at ½ thickness positions of the joining portion (positions separated from the interface between the copper or copper alloy and the joining metal by a length towards the stainless steel side equal to the thickness of the joining portion obtained from the observation described above divided by 2). The Sn content (mass %) measured at each point is then averaged to obtain the Sn content of the joining portion of the cross-section sample. This measurement is carried out on four cross-section samples prepared by randomly sampling from the joining portion, and an average value of the Sn content of the joining portion of each cross-section sample is taken as the Sn content of the joining portion.

When the copper end or the stainless steel end has a chamfered edge on the overlapping surface side so that the joining metal can easily flow in-between the overlapping surfaces of the material to be joined during joining, the thickness of the joining portion will not be uniform. Further, when chamfering is carried out, it is preferable that an angle between the chamfered surface and the surface of the other material to be joined is 5 degrees to 10 degrees. A length of the chamfered surface is preferably 1.0 mm to 3.0 mm in the perpendicular-to-joining direction.

Further, when the width of the joining portion is not uniform, for example, when the width is different near the stainless steel or near the copper or copper alloy, that is, when the width of the joining portion varies depending on the thickness direction position, a minimum length of the joining portion in the perpendicular-to-joining direction at a thickness direction position between the overlapping surfaces of the material to be joined is taken as the width of the joining portion.

A portion of the joining portion may protrude beyond the overlapping surfaces of the material to be joined in the perpendicular-to-joining direction. In such a case, the thickness and the width of the joining portion are measured excluding the portion that protrudes beyond the overlapping surfaces of the material to be joined.

Further, the joining portion may be connected by crimping or fitted, depending on the strength and airtightness required.

The joined body according to an embodiment of the present disclosure may be either sheet-shaped (including not only flat sheets but also curved sheets (bent sheets)) or tubular. When tubular, the joined body is a stainless steel pipe or tube and a copper or copper alloy pipe or tube. For example, the following combinations are possible. In these combinations, a portion of the stainless steel pipe or tube may be inserted into the copper or copper alloy pipe or tube, or a portion of the copper or copper alloy pipe or tube may be inserted into the stainless steel pipe or tube, and joined.
A combination of a copper or copper alloy pipe or tube and a stainless steel pipe or tube, where an outer diameter of the stainless steel pipe or tube and an inner diameter of the copper or copper alloy pipe or tube are roughly equal
A combination of a copper or copper alloy pipe or tube with an end expanded to roughly equal an outer diameter of a stainless steel pipe or tube, and the stainless steel pipe or tube
A combination of a stainless steel pipe or tube with an end decreased to roughly equal an inside diameter of a copper or copper alloy pipe or tube, and the copper or copper alloy pipe or tube, and the like

Further, a joined body according to an embodiment of the present disclosure includes a joined body including a plurality of joining portions, at least one of which is the joining portion described above.

### [3] Method of Producing a Joined Body of Stainless Steel and Copper or Copper Alloy

The following describes a method of producing a joined body of stainless steel and copper or copper alloy (hereinafter also referred to as a method of producing a joined body) according to an embodiment of the present disclosure.

A method of producing a joined body according to an embodiment of the present disclosure includes a process of joining stainless steel and copper or copper alloy by the joining method described under [1], above.

The method of producing a joined body according to an embodiment of the present disclosure can suitably produce the joined body described under [2], above.

### EXAMPLES

### Example Group 1

A stainless steel sheet (SUS443J1 as defined in JIS G 4305:2021) having a thickness of 1.0 mm and a copper sheet (phosphorus-deoxidized copper sheet (C1220) as defined in JIS H 3100:2018) or a copper alloy sheet (C2680 as defined in JIS H 3100:2018) having a thickness of 1.0 mm were each cut into 120 mm squares. Next, the copper sheet or the copper alloy sheet was placed on the stainless steel sheet so that the stainless steel sheet and the copper sheet or the copper alloy sheet overlapped with an overlap width L listed in Table 1 (the arrangement illustrated in FIG. 1), thereby obtaining material to be joined. At this time, spacers were placed between the stainless steel sheet and the copper sheet or the copper alloy sheet at both ends of the overlapping portion of the material to be joined in the joining progress direction so that the gaps listed in Table 1 were obtained, and the material to be joined was then clamped with clips. Further, flux (BS-45, produced by Taiyo Electric Industry Co., Ltd.) was applied in advance to the surface of the stainless steel at and near the overlapping surface of the material to be joined.

Next, as illustrated in FIG. 1, thermocouples were attached to a surface (first surface) of the stainless steel at intervals of 5 mm in the joining progress direction, at positions 10 mm away from the copper end of the material to be joined toward the stainless steel side in the perpendicular-to-joining direction (position +10 mm from the copper end that was the reference position (0 mm)).

Next, a rod-shaped solder (Sn96.5Ag3Cu0.5 as specified in JIS Z 3282:2017) having a diameter of 2.0 mm was placed at the copper end vicinity of the material to be joined.

Next, while moving the heating device in the joining progress direction, the material to be joined was heated from the upper surface of the copper sheet or the copper alloy sheet to join the stainless steel sheet and the copper sheet or the copper alloy sheet, thereby obtaining a joined body of stainless steel and copper or copper alloy. The heated position was a position 20 mm away from the copper end, which was the reference position, towards the copper side (−20 mm position). For Test No. 1-15 and Test No. 1-16 in Table 1, the material to be joined was heated from the bottom surface of the stainless steel, and the heated position was a position 20 mm away from the copper end, which was the reference position, towards the stainless steel side (+20 mm position). The heating device used was a torch that utilizes a gas flame, a so-called gas burner (RZ-820, produced by Shinfuji Burner Co., Ltd., heat amount: 2300 kcal/h, nozzle diameter: 16 mm). In all cases, the joining was carried out in an air atmosphere. Further, conditions not specified were in accordance with the descriptions in the general description section above and conventional methods. During the joining, the temperature of the stainless steel was measured and recorded at intervals of 0.1 s using the thermocouple and a temperature logger, and the heating pattern of the stainless steel was obtained from the output temperature log. From the obtained heating pattern of the stainless steel, the following was derived:
(I) maximum arrival temperature of the stainless steel, and
(II) residence time of the stainless steel at 150 °C or higher.
The results are listed in Table 1.

(I) and (II) were derived for each temperature measurement point where a thermocouple was installed. Further, Table 1 lists only a maximum value of (I) and a minimum and a maximum value of (II) for the temperature measurement points. For the Examples according to the present disclosure, (I) and (II) satisfied the ranges described above at all temperature measurement points. The same applies to Example Group 2 described later.

Four cross-section samples were cut out from the joined body obtained as described above, and the thickness and the width of the joining portion of each cross-section sample were measured. Further, joining was evaluated based on the following criteria. The results are listed in Table 1.
Pass: the width of the joining portion was 1.0 mm or more in all four cross-section samples.
Fail: the width of the joining portion was less than 1.0 mm in at least one cross-section sample.

Next, from the thickness and the width of the joining portion in each cross-section sample measured as described above, the following were calculated:
(III) average thickness of the joining portion, and
(IV) average width of joining portion.

Further, as described above, the following was measured:
(V) Sn content (mass %) of the joining portion.

The results are listed in Table 1. When joining was evaluated as failed, calculation and measurement of (III) to (V) were not carried out. Further, the average width of the joining portion was equivalent to the overlap width L, which means that the entirety of the overlapping surfaces of the material to be joined became the joining portion.

Here, the thickness and the width of the joining portion were measured using an optical microscope DSX510, produced by Olympus Corporation (now Evident Corporation). Further, in measurement of the Sn content (mass %) of the joining portion, a scanning electron microscope (SEM), Miniscope® (Miniscope is a registered trademark in Japan, other countries, or both) TM3030plus, produced by Hitachi High-Tech Corporation, and an energy-dispersive X-ray spectrometer (EDS) AZtecOne, produced by Oxford Instruments, Ltd., were used.

TABLE 1

| | | | | Joining conditions | | | | | | | | |
|---|---|---|---|---|---|---|---|---|---|---|---|---|
| | | | | | | (II) | (II) | | | | | |
| | | | | | (I) | Residence | Residence | | | | | |
| | Material to be joined | | | | Maximum | time of | time of | Joined body | | | | |
| | Type of | | | | arrival | stainless | stainless | (III) | (IV) | | | |
| | copper | | | | tempera- | steel at | steel at | Average | Average | (V) | Evalu- | |
| | sheet or | | | | ture of | 150 °C | 150 °C | thickness | width | Sn content | ation | |
| | copper | Overlap | | | stainless | or higher | or higher | of joining | of joining | of joining | Joining | |
| Test | alloy | width L | Gap | Heated | steel | (minimum | (maximum | portion | portion | portion | evalu- | |
| No. | sheet | (mm) | (mm) | location | (°C) | value) (s) | value) (s) | (mm) | (mm) | (mass %) | ation | Remarks |
| 1-1 | C2680 | 10.0 | 0.04 | copper | 285 | 45 | 60 | 0.04 | 6.9 | 96.5 | pass | Example |
| 1-2 | C2680 | 10.0 | 0.10 | copper | 295 | 160 | 170 | 0.10 | 4.3 | 96.3 | pass | Example |
| 1-3 | C2680 | 5.0 | 0.18 | copper | 290 | 48 | 50 | 0.18 | 5.0 | 96.3 | pass | Example |
| 1-4 | C2680 | 30.0 | 0.02 | copper | 275 | 8 | 18 | 0.02 | 12.2 | 96.5 | pass | Example |
| 1-5 | C2680 | 10.0 | 0.04 | copper | 320 | 50 | 60 | 0.04 | 8.4 | 96.2 | pass | Example |
| 1-6 | C2680 | 10.0 | 0.04 | copper | 285 | 190 | 210 | 0.04 | 8.9 | 96.2 | pass | Example |
| 1-7 | C2680 | 10.0 | 0.04 | copper | 285 | 45 | 60 | 0.04 | 7.5 | 96.4 | pass | Example |
| 1-8 | C2680 | 10.0 | 0.04 | copper | 285 | 7 | 14 | 0.04 | 4.7 | 96.5 | pass | Example |
| 1-9 | C2680 | 10.0 | 0.04 | copper | 245 | 5 | 6 | 0.04 | 3.1 | 96.5 | pass | Example |
| 1-10 | C2680 | 10.0 | 0.46 | copper | 285 | 45 | 60 | 0.46 | 5.3 | 96.5 | pass | Example |
| 1-11 | C1220 | 10.0 | 0.04 | copper | 235 | 54 | 60 | 0.04 | 7.6 | 96.2 | pass | Example |
| 1-12 | C2680 | 10.0 | 0.04 | copper | 365 | 55 | 60 | — | — | — | fail | Compar- |
| | | | | | | | | | | | | ative |
| | | | | | | | | | | | | Example |
| 1-13 | C2680 | 10.0 | 0.04 | copper | 285 | 335 | 360 | — | — | — | fail | Compar- |
| | | | | | | | | | | | | ative |
| | | | | | | | | | | | | Example |
| 1-14 | C2680 | 10.0 | 0.04 | copper | 245 | 0 | 2 | — | — | — | fail | Compar- |
| | | | | | | | | | | | | ative |
| | | | | | | | | | | | | Example |
| 1-15 | C2680 | 10.0 | 0.04 | stainless | 235 | 20 | 30 | — | — | — | fail | Compar- |
| | | | | steel | | | | | | | | ative |
| | | | | | | | | | | | | Example |
| 1-16 | C2680 | 10.0 | 0.04 | stainless | 370 | 20 | 30 | — | — | — | fail | Compar- |
| | | | | steel | | | | | | | | ative |
| | | | | | | | | | | | | Example |

As indicated in Table 1, for all of the Examples according to the present disclosure, a joined body of stainless steel and copper or copper alloy was obtained by a simple joining method in an air environment, while using a cost-effective Sn alloy as the joining metal.

In contrast, for all of the Comparative Examples, the stainless steel and the copper alloy were not properly joined.

That is, for the Comparative Example of Test No. 1-12, the maximum arrival temperature of the stainless steel exceeded the appropriate range, and therefore joining failed.

For the Comparative Example of Test No. 1-13, the residence time of the stainless steel at 150 °C or higher exceeded the appropriate range, and therefore joining failed.

For the Comparative Example of Test No. 1-14, the residence time of the stainless steel at 150 °C or higher was below the appropriate range, and therefore joining failed.

For the Comparative Example of Test No. 1-15, the heated location was stainless steel, and therefore joining failed.

For the Comparative Example of Test No. 1-16, the heated location was stainless steel, which caused the temperature of the stainless steel to increase excessively, and therefore joining failed.

### Example Group 2

A stainless steel tube having an outer diameter and a thickness (wall thickness) listed in Table 2, and a copper tube (phosphorus-deoxidized copper tube (C1220T) specified in JIS H 3300:2018) or a copper alloy tube (brass tube (C2700T) specified in JIS H 3100:2018) having an outer diameter and a thickness (wall thickness) listed in Table 2 were cut into lengths of 300 mm, and the stainless steel tube was inserted into the copper tube or the copper alloy tube (the arrangement illustrated in FIG. 1), or the copper tube or the copper alloy tube was inserted into the stainless steel tube (the arrangement illustrated in FIG. 2) so that the overlap width L was 10 mm, to form the material to be joined. At this time, the outer circumference of the end of the tube on the smaller diameter side, corresponding to the overlapping portion, was ground or polished in advance to adjust the gap between the stainless steel tube and the copper tube or the copper alloy tube to 0.05 mm. Further, the same flux as for Example Group 1 was applied in advance to the outer surface of the smaller diameter tube at and near the overlapping surface of the material to be joined.

Next, for the material to be joined in which the stainless steel tube was inserted into the copper tube or the copper alloy tube, thermocouples were attached to the outer surface (first surface) of the stainless steel tube at positions 20 mm away from the copper end of the material to be joined toward the stainless steel side in the perpendicular-to-joining direction (position +20 mm from the copper end that was the reference position (0 mm)), at intervals of 4 mm in the joining progress direction (circumferential direction). Further, for the material to be joined in which the copper tube or the copper alloy tube was inserted into the stainless steel tube, thermocouples were attached to the outer surface (second surface) of the stainless steel tube at positions 20 mm away from the stainless steel end of the material to be joined toward the stainless steel side in the perpendicular-to-joining direction (position +20 mm from the stainless steel end that was the reference position (0 mm)), at intervals of 4 mm in the joining progression direction (circumferential direction).

Next, a 1.0 mm diameter bar-shaped solder (solder specified in JIS Z 3282:2017) listed in Table 2 was wound around the outer circumference of the small diameter tube in the vicinity of the large diameter tube end of the material to be joined.

Next, while moving the heating device in the joining progress direction (circumferential direction), the material to be joined was heated from outside the tube, joining the stainless steel tube and the copper tube or the copper alloy tube, thereby obtaining a joined body of stainless steel and copper or copper alloy. The heated position was a position 20 mm away from the reference position (stainless steel end or copper end) on the copper side (−20 mm position). Here, a torch using a gas flame, a so-called gas burner, was used as the heating device. The gas burner used was the same as that used for Example Group 1 above. In all cases, the joining was carried out in an air atmosphere. Further, conditions not specified were in accordance with the descriptions in the general description section above and conventional methods. Then, from the heating pattern of the stainless steel obtained as for Example Group 1, the following was derived:
(I) maximum arrival temperature of the stainless steel, and
(II) residence time of the stainless steel at 150 °C or higher.
Results are listed in Table 2.

Further, the joined bodies obtained were then evaluated for joining, as for Example Group 1. Further, as for Example Group 1, the following were calculated and measured:
(III) average thickness of the joining portion,
(IV) average width of joining portion, and
(V) Sn content (mass %) of the joining portion.
Results are listed in Table 2.

TABLE 2

| | | | | Copper tube or | | | | |
|---|---|---|---|---|---|---|---|---|
| | Stainless steel tube | | | copper alloy tube | | | | Joining |
| | Outer | Wall | | Outer | Wall | | | conditions |
| Test | diameter | thickness | Steel | diameter | thickness | | Joining | Heated |
| No. | (mm) | (mm) | type | (mm) | (mm) | Type | metal | location |
| 2-1 | 10.0 | 0.5 | SUS443J1 | 12.0 | 1.0 | C1220T | Sn96.5Ag3.5 | copper |
| 2-2 | 12.0 | 1.0 | SUS445J1 | 10.0 | 0.5 | C1220T | Sn99.3Cu0.7 | copper |
| 2-3 | 16.0 | 1.0 | SUS304 | 18.0 | 1.0 | C1220T | Sn95Sb5 | copper |
| 2-4 | 18.0 | 1.0 | SUS430J1L | 16.0 | 1.0 | C1220T | Sn96.5Ag3Cu0.5 | copper |
| 2-5 | 10.0 | 0.5 | SUS444 | 13.0 | 1.5 | C1220T | Sn96Ag2.5Bi1Cu0.5 | copper |
| 2-6 | 5.0 | 0.4 | SUS443J1 | 6.0 | 0.5 | C1220T | Sn92In4Ag3.5Bi0.5 | copper |
| 2-7 | 6.0 | 0.5 | SUS445J1 | 5.0 | 0.4 | C1220T | Sn91Zn9 | copper |
| 2-8 | 32.0 | 1.0 | SUS316L | 30.0 | 1.0 | C1220T | Sn89Zn8Bi3 | copper |
| 2-9 | 25.0 | 0.8 | SUS430J1L | 30.0 | 2.5 | C1220T | Bi58Sn42 | copper |
| 2-10 | 19.0 | 1.5 | SUS444 | 16.0 | 2.0 | C1220T | In52Sn48 | copper |
| 2-11 | 10.0 | 0.5 | SUS443J1 | 12.0 | 1.0 | C1220T | Sn60Pb40 | copper |
| 2-12 | 10.0 | 0.5 | SUS443J2 | 12.0 | 1.0 | C2700T | Sn96.5Ag3.5 | copper |
| 2-13 | 10.0 | 0.5 | SUS443J1 | 12.0 | 1.0 | C1220T | Pb70Sn30 | copper |

| | Joining conditions | | | | | | | |
|---|---|---|---|---|---|---|---|---|
| | | (II) | (II) | | | | | |
| | (I) | Residence | Residence | | | | | |
| | Maximum | time of | time of | Joined body | | | | |
| | arrival | stainless | stainless | (III) | (IV) | | | |
| | tempera- | steel at | steel at | Average | Average | (V) | Evalu- | |
| | ture of | 150 °C | 150 °C | thickness | width of | Sn content | ation | |
| | stainless | or higher | or higher | of joining | joining | of joining | Joining | |
| Test | steel | (minimum | (maximum | portion | portion | portion | evalu- | |
| No. | (°C) | value) (s) | value) (s) | (mm) | (mm) | (mass %) | ation | Remarks |
| 2-1 | 280 | 33 | 40 | 0.05 | 6.9 | 96.4 | pass | Example |
| 2-2 | 280 | 35 | 40 | 0.05 | 7.2 | 99.2 | pass | Example |
| 2-3 | 280 | 34 | 40 | 0.05 | 6.7 | 94.8 | pass | Example |
| 2-4 | 280 | 33 | 40 | 0.05 | 7.3 | 96.3 | pass | Example |
| 2-5 | 280 | 33 | 40 | 0.05 | 7.5 | 95.8 | pass | Example |
| 2-6 | 280 | 34 | 40 | 0.05 | 7.3 | 91.6 | pass | Example |
| 2-7 | 280 | 32 | 40 | 0.05 | 7.4 | 90.5 | pass | Example |
| 2-8 | 280 | 33 | 40 | 0.05 | 7.2 | 88.2 | pass | Example |
| 2-9 | 280 | 35 | 40 | 0.05 | 7.2 | 41.1 | pass | Example |
| 2-10 | 280 | 33 | 40 | 0.05 | 7.3 | 47.8 | pass | Example |
| 2-11 | 280 | 34 | 40 | 0.05 | 7.6 | 59.6 | pass | Example |
| 2-12 | 280 | 35 | 39 | 0.05 | 7.2 | 96.3 | pass | Example |
| 2-13 | 280 | 33 | 40 | — | — | — | fail | Compar- |
| | | | | | | | | ative |
| | | | | | | | | Example |

As indicated in Table 2, for all of the Examples according to the present disclosure, a joined body of stainless steel and copper or copper alloy was obtained by a simple joining method in an air environment, while using a cost-effective Sn alloy as the joining metal.

In contrast, for the Comparative Example of Test No. 2-13, the Sn content of the joining metal was below the appropriate range, and therefore the joining metal was not melted sufficiently and joining failed.

### Example Group 3

A stainless steel sheet (SUS443J1 as defined in JIS G 4305:2021) having a thickness of 1.0 mm and a copper sheet (phosphorus-deoxidized copper sheet (C1220) as defined in JIS H 3100:2018, thermal conductivity: 339 W/mK) or a copper alloy sheet (brass plate (C2680) as defined in JIS H 3100:2018, thermal conductivity: 117 W/mK) having a thickness of 1.0 mm were each cut into 120 mm squares. Next, the copper sheet or the copper alloy sheet was placed on the stainless steel sheet so that the stainless steel sheet and the copper sheet or the copper alloy sheet overlapped with an overlap width L listed in Table 3, thereby obtaining material to be joined. At this time, spacers were placed between the stainless steel sheet and the copper sheet or the copper alloy sheet at both ends of the overlapping portion of the material to be joined in the joining progress direction so that the gaps listed in Table 3 were obtained, and the stainless steel sheet and the copper sheet or the copper alloy sheet was then clamped with clips. Further, flux (BS-45, produced by Taiyo Electric Industry Co., Ltd.) was applied in advance to the surface of the stainless steel at and near the overlapping surface of the material to be joined.

Next, as illustrated in FIG. 1, thermocouples were attached to a surface (first surface) of the stainless steel at intervals of 5 mm in the joining progress direction, at positions 10 mm away from the copper end of the material to be joined toward the stainless steel side in the perpendicular-to-joining direction (position +10 mm from the copper end that was the reference position (0 mm)).

Next, a rod-shaped solder (Sn96.5Ag3Cu0.5 as specified in JIS Z 3282:2017) having a diameter of 2.0 mm was placed at the copper end vicinity of the material to be joined.

Next, the heating device was moved in the joining progress direction while the heater of the heating device was brought into contact with the material to be joined at a contact position listed in Table 3. This melted the joining metal to join the stainless steel and the copper or copper alloy, thereby obtaining a joined body. Here, a soldering iron (SS-152J (150 W), a soldering iron for sheet metal manufactured by Ishizaki Electric Mfg. Co., Ltd.) was used as the heating device. In all cases, the joining was carried out in an air atmosphere. Further, conditions not specified were in accordance with the descriptions in the general description section above and conventional methods. During the joining, the temperature of the stainless steel was measured and recorded at intervals of 0.1 s using the thermocouple and a temperature logger, and the heating pattern of the stainless steel was obtained from the output temperature log. From the obtained heating pattern of the stainless steel, the following was derived:
(I) maximum arrival temperature of the stainless steel, and
(II) residence time of the stainless steel at 100 °C or higher.
The results are listed in Table 3.

(I) and (II) were derived for each temperature measurement point where a thermocouple was installed. Further, Table 3 lists only a maximum value of (I) and a minimum and a maximum value of (II) for the temperature measurement points. For the Examples according to the present disclosure, (I) and (II) satisfied the ranges described above at all temperature measurement points. The same applies to Example Group 4 described later.

Further, the joined bodies obtained were then evaluated for joining, as for Example Group 1. Further, as for Example Group 1, the following were calculated and measured:
(III) average thickness of the joining portion,
(IV) average width of joining portion, and
(V) Sn content (mass %) of the joining portion.
The results are listed in Table 3.

TABLE 3

| | Material to be joined | | | | Joining conditions | | | | | | | | |
|---|---|---|---|---|---|---|---|---|---|---|---|---|---|
| | | | | Thermal | | | (II) | (II) | | | | | |
| | | | | conduc- | | (I) | Residence | Residence | | | | | |
| | | | | tivity | | Maximum | time of | time of | Joined body | | | | |
| | | | Type of | of copper | | arrival | stainless | stainless | (III) | (IV) | | Evalu- | |
| | | | copper | sheet or | | tempera- | steel at | steel at | Average | Average | (V) | ation | |
| | | | sheet or | copper | | ture of | 100 °C | 100 °C | thickness | width | Sn content | (VI) | |
| | Overlap | | copper | alloy | Contact | stainless | or higher | or higher | of joining | of joining | of joining | Joining | |
| Test | width L | Gap | alloy | sheet | position | steel | (minimum | (maximum | portion | portion | portion | evalu- | |
| No. | (mm) | (mm) | sheet | (W/mK) | (mm) | (°C) | value) (s) | value) (s) | (mm) | (mm) | (mass %) | ation | Remarks |
| 3-1 | 10.0 | 0.04 | C1220 | 339 | +1 | 235 | 5 | 10 | 0.04 | 3.1 | 96.3 | pass | Example |
| 3-2 | 10.0 | 0.10 | C1220 | 339 | +2 | 180 | 6 | 14 | 0.10 | 2.3 | 96.5 | pass | Example |
| 3-3 | 10.0 | 0.10 | C1220 | 339 | +4 | 160 | 95 | 120 | 0.10 | 4.1 | 96.0 | pass | Example |
| 3-4 | 10.0 | 0.46 | C1220 | 339 | +14 | 150 | 35 | 60 | 0.46 | 6.0 | 96.5 | pass | Example |
| 3-5 | 10.0 | 0.04 | C2680 | 117 | −2 | 235 | 54 | 60 | 0.04 | 7.6 | 96.2 | pass | Example |
| 3-6 | 7.5 | 0.18 | C2680 | 117 | +2 | 200 | 40 | 90 | 0.18 | 5.0 | 96.6 | pass | Example |
| 3-7 | 20.0 | 0.02 | C2680 | 117 | +8 | 185 | 55 | 80 | 0.02 | 12.3 | 96.1 | pass | Example |
| 3-8 | 10.0 | 0.04 | C2680 | 117 | −5 | 220 | 45 | 60 | 0.04 | 7.1 | 96.1 | pass | Example |
| 3-9 | 10.0 | 0.04 | C2680 | 117 | −14 | 230 | 230 | 265 | 0.04 | 7.9 | 96.5 | pass | Example |
| 3-10 | 10.0 | 0.04 | C2680 | 117 | +4 | 200 | 80 | 120 | 0.04 | 6.5 | 96.6 | pass | Example |
| 3-11 | 10.0 | 0.04 | C2680 | 117 | +1 | 235 | 5 | 6 | 0.04 | 1.7 | 96.6 | pass | Example |
| 3-12 | 10.0 | 0.04 | C1220 | 339 | +14 | 235 | 320 | 360 | — | — | — | fail | Compar- |
| | | | | | | | | | | | | | ative |
| | | | | | | | | | | | | | Example |
| 3-13 | 10.0 | 0.04 | C1220 | 339 | −2 | 83 | 0 | 0 | — | — | — | fail | Compar- |
| | | | | | | | | | | | | | ative |
| | | | | | | | | | | | | | Example |
| 3-14 | 10.0 | 0.04 | C1220 | 339 | +20 | 82 | 0 | 0 | — | — | — | fail | Compar- |
| | | | | | | | | | | | | | ative |
| | | | | | | | | | | | | | Example |
| 3-15 | 10.0 | 0.04 | C2680 | 117 | 0 | 365 | 57 | 60 | — | — | — | fail | Compar- |
| | | | | | | | | | | | | | ative |
| | | | | | | | | | | | | | Example |
| 3-16 | 10.0 | 0.04 | C2680 | 117 | 0 | 235 | 0 | 3 | — | — | — | fail | Compar- |
| | | | | | | | | | | | | | ative |
| | | | | | | | | | | | | | Example |
| 3-17 | 10.0 | 0.04 | C2680 | 117 | +17 | 81 | 0 | 0 | — | — | — | fail | Compar- |
| | | | | | | | | | | | | | ative |
| | | | | | | | | | | | | | Example |
| 3-18 | 10.0 | 0.04 | C2680 | 117 | −20 | 96 | 0 | 0 | — | — | — | fail | Compar- |
| | | | | | | | | | | | | | ative |
| | | | | | | | | | | | | | Example |

As indicated in Table 3, for all of the Examples according to the present disclosure, a joined body of stainless steel and copper or copper alloy was obtained by a simple joining method in an air environment, while using a cost-effective Sn alloy as the joining metal. Further, no discoloration (temper color) was observed on the surface of the stainless steel.

In contrast, for all of the Comparative Examples, the stainless steel and the copper or copper alloy were not properly joined.

That is, for the Comparative Example of Test No. 3-12, the residence time of the stainless steel at 100 °C or higher exceeded the appropriate range, and therefore joining failed.

For the Comparative Example of Test No. 3-13, the contact position was outside the appropriate range, the stainless steel did not reach 100 °C or higher, and the residence time at 100 °C or higher was less than the appropriate range, and therefore joining failed.

For the Comparative Example of Test No. 3-14, the contact position was outside the appropriate range, the stainless steel did not reach 100 °C or higher, and the residence time at 100 °C or higher was less than the appropriate range, and therefore joining failed.

For the Comparative Example of Test No. 3-15, the maximum arrival temperature of the stainless steel exceeded the appropriate range, and therefore joining failed.

For the Comparative Example of Test No. 3-16, the residence time of the stainless steel at 100 °C or higher was below the appropriate range, and therefore joining failed.

For the Comparative Example of Test No. 3-17, the contact position was outside the appropriate range, the stainless steel did not reach 100 °C or higher, and the residence time at 100 °C or higher was less than the appropriate range, and therefore joining failed.

For the Comparative Example of Test No. 3-18, the contact position was outside the appropriate range, the stainless steel did not reach 100 °C or higher, and the residence time at 100 °C or higher was less than the appropriate range, and therefore joining failed.

### Example Group 4

A stainless steel tube having an outer diameter and a thickness (wall thickness) listed in Table 4, and a copper tube (phosphorus-deoxidized copper tube (C1220T) specified in JIS H 3300:2018) or a copper alloy tube (brass tube (C2700T) specified in JIS H 3100:2018) having an outer diameter and a thickness (wall thickness) listed in Table 4 were cut into lengths of 300 mm, and the stainless steel tube was inserted into the copper tube or the copper alloy tube (the arrangement illustrated in FIG. 1), or the copper tube or the copper alloy tube was inserted into the stainless steel tube (the arrangement illustrated in FIG. 2) so that the overlap width L was 10 mm, to form the material to be joined. At this time, the outer circumference of the end of the tube on the smaller diameter side, corresponding to the overlapping portion, was ground or polished in advance to adjust the gap between the stainless steel tube and the copper tube or the copper alloy tube to 0.05 mm. Further, the same flux as for Example Group 3 was applied in advance to the outer surface of the smaller diameter tube at and near the overlapping surface of the material to be joined.

Next, for the material to be joined in which the stainless steel tube was inserted into the copper tube or the copper alloy tube, thermocouples were attached to the outer surface (first surface) of the stainless steel tube at positions 15 mm away from the copper end of the material to be joined toward the stainless steel side in the perpendicular-to-joining direction (position +15 mm from the copper end that was the reference position (0 mm)), at intervals of 4 mm in the joining progress direction (circumferential direction). Further, for the material to be joined in which the copper tube or the copper alloy tube was inserted into the stainless steel tube, thermocouples were attached to the outer surface (second surface) of the stainless steel tube at positions 15 mm away from the stainless steel end of the material to be joined toward the stainless steel side in the perpendicular-to-joining direction (position +15 mm from the stainless steel end that was the reference position (0 mm)), at intervals of 4 mm in the joining progression direction (circumferential direction).

Next, a 1.0 mm diameter bar-shaped solder (solder specified in JIS Z 3282:2017) listed in Table 4 was wound around the outer circumference of the small diameter tube in the vicinity of the large diameter tube end of the material to be joined.

Next, the heating device was moved in the joining progress direction (circumferential direction) while the heater of the heating device was brought into contact with the material to be joined. The contact position was as listed in Table 4. This melted the joining metal to join the stainless steel and the copper or copper alloy, thereby obtaining a joined body. Here, the same soldering iron as for Example Group 3 was used as the heating device. In all cases, the joining was carried out in an air atmosphere. Further, conditions not specified were in accordance with the descriptions in the general description section above and conventional methods. Then, from the heating pattern of the stainless steel obtained as for Example Group 3, the following was derived:
(I) maximum arrival temperature of the stainless steel, and
(II) residence time of the stainless steel at 100 °C or higher.
Results are listed in Table 4.

Further, the joined bodies obtained were then evaluated for joining, as for Example Group 1. Further, as for Example Group 1, the following were calculated and measured:
(III) average thickness of the joining portion,
(IV) average width of joining portion, and
(V) Sn content (mass %) of the joining portion.
The results are listed in Table 4.

TABLE 4

| | | | | Copper tube or | | | | |
|---|---|---|---|---|---|---|---|---|
| | | | | copper alloy tube | | | | |
| | Stainless steel tube | | | | | | Thermal | |
| | Outer | Wall | | Outer | Wall | | conduc- | |
| Test | diameter | thickness | Steel | diameter | thickness | | tivity | Joining |
| No. | (mm) | (mm) | type | (mm) | (mm) | Type | (W/mK) | metal |
| 4-1 | 10.0 | 0.5 | SUS443J1 | 12.0 | 1.0 | C1220T | 339 | Sn96.5Ag3.5 |
| 4-2 | 12.0 | 1.0 | SUS445J1 | 10.0 | 0.5 | C1220T | 339 | Sn99.3Cu0.7 |
| 4-3 | 16.0 | 1.0 | SUS304 | 18.0 | 1.0 | C1220T | 339 | Sn95Sb5 |
| 4-4 | 18.0 | 1.0 | SUS430J1L | 16.0 | 1.0 | C1220T | 339 | Sn96.5Ag3Cu0.5 |
| 4-5 | 10.0 | 0.5 | SUS444 | 13.0 | 1.5 | C1220T | 339 | Sn96Ag2.5Bi1Cu0.5 |
| 4-6 | 5.0 | 0.4 | SUS443J1 | 6.0 | 0.5 | C1220T | 339 | Sn92In4Ag3.5Bi0.5 |
| 4-7 | 6.0 | 0.5 | SUS445J1 | 5.0 | 0.4 | C1220T | 339 | Sn91Zn9 |
| 4-8 | 32.0 | 1.0 | SUS316L | 30.0 | 1.0 | C1220T | 339 | Sn89Zn8Bi3 |
| 4-9 | 25.0 | 0.8 | SUS430J1L | 30.0 | 2.5 | C1220T | 339 | Bi58Sn42 |
| 4-10 | 19.0 | 1.5 | SUS444 | 16.0 | 2.0 | C1220T | 339 | In52Sn48 |
| 4-11 | 10.0 | 0.5 | SUS443J1 | 12.0 | 1.0 | C1220T | 339 | Sn60Pb40 |
| 4-12 | 10.0 | 0.5 | SUS443J2 | 12.0 | 1.0 | C2700T | 117 | Sn96.5Ag3.5 |
| 4-13 | 10.0 | 0.5 | SUS443J1 | 12.0 | 1.0 | C1220T | 339 | Pb70Sn30 |

| | Joining conditions | | | | | | | | |
|---|---|---|---|---|---|---|---|---|---|
| | | | (II) | (II) | | | | | |
| | | (I) | Residence | Residence | | | | | |
| | | Maximum | time of | time of | Joined body | | | | |
| | | arrival | stainless | stainless | (III) | (IV) | | Evalu- | |
| | | tempera- | steel at | steel at | Average | Average | (V) | ation | |
| | | ture of | 100 °C | 100 °C | thickness | width | Sn content | (VI) | |
| | Contact | stainless | or higher | or higher | of joining | of joining | of joining | Joining | |
| Test | position | steel | (minimum | (maximum | portion | portion | portion | evalu- | |
| No. | (mm) | (°C) | value) (s) | value) (s) | (mm) | (mm) | (mass %) | ation | Remarks |
| 4-1 | +2 | 230 | 32 | 40 | 0.05 | 6.2 | 96.2 | pass | Example |
| 4-2 | +13 | 208 | 123 | 142 | 0.05 | 4.2 | 99.1 | pass | Example |
| 4-3 | +5 | 246 | 43 | 64 | 0.05 | 6.3 | 95.1 | pass | Example |
| 4-4 | +2 | 230 | 32 | 40 | 0.05 | 6.1 | 96.4 | pass | Example |
| 4-5 | +3 | 233 | 37 | 45 | 0.05 | 4.6 | 95.5 | pass | Example |
| 4-6 | +2 | 230 | 33 | 40 | 0.05 | 6.2 | 91.3 | pass | Example |
| 4-7 | +13 | 194 | 98 | 127 | 0.05 | 5.1 | 90.4 | pass | Example |
| 4-8 | +8 | 198 | 68 | 92 | 0.05 | 6.1 | 88.7 | pass | Example |
| 4-9 | +4 | 185 | 18 | 24 | 0.05 | 4.1 | 41.0 | pass | Example |
| 4-10 | +2 | 230 | 32 | 40 | 0.05 | 5.9 | 48.3 | pass | Example |
| 4-11 | +13 | 208 | 127 | 138 | 0.05 | 4.2 | 59.2 | pass | Example |
| 4-12 | −2 | 230 | 31 | 40 | 0.05 | 6.1 | 96.3 | pass | Example |
| 4-13 | +2 | 230 | 32 | 40 | — | — | — | fail | Compar- |
| | | | | | | | | | ative |
| | | | | | | | | | Example |

As indicated in Table 4, for all of the Examples according to the present disclosure, a joined body of stainless steel and copper or copper alloy was obtained by a simple joining method in an air environment, while using a cost-effective Sn alloy as the joining metal. Further, no discoloration (temper color) was observed on the surface of the stainless steel.

In contrast, for the Comparative Example of Test No. 4-13, the Sn content of the joining metal was below the appropriate range, and therefore the joining metal was not melted sufficiently and joining failed.

### INDUSTRIAL APPLICABILITY

A joined body according to an embodiment of the present disclosure is suitable for application to a variety of products, including heat exchanger pipes or tubes, hot water supply pipes or tubes, water supply pipes or tubes, gas hot water heater pipes or tubes, air conditioner pipes or tubes, housing pipes or tubes, electronic device components, and household electrical appliances.

1. A method of joining stainless steel and copper or copper alloy, the method comprising a joining process of joining material to be joined by using joining metal, the material to be joined being stainless steel and copper or copper alloy overlapped with each other, wherein
the joining metal is Sn or Sn alloy having a Sn content of 40 mass % or more, and
in the joining process:
the copper or copper alloy is heated by a heating device, and heat transfer from the copper or copper alloy causes the joining metal to be melted and the stainless steel to be heated, joining the stainless steel and the copper or copper alloy,
a maximum arrival temperature of the stainless steel is 350 °C or lower, and
a residence time of the stainless steel in a temperature range of 150 °C or higher is 5 s or longer to 5 min or shorter.

2. The method of joining stainless steel and copper or copper alloy according to claim 1, wherein the heating device is a torch.

3. A method of joining stainless steel and copper or copper alloy, the method comprising a joining process of joining material to be joined by using joining metal, the material to be joined being stainless steel and copper or copper alloy overlapped with each other, wherein
the joining metal is Sn or Sn alloy having a Sn content of 40 mass % or more, and
in the joining process:
a heating device including a heater is used, the heater is brought into contact with the material to be joined, thereby melting the joining metal and joining the stainless steel and the copper or copper alloy,
a contact position between the heater and the material to be joined in a perpendicular-to-joining direction is defined relative to a reference position, 0 mm, at an overlap end that is an initiation point for spreading the joining metal in-between overlapping surfaces of the material to be joined, with the stainless steel side as +ve and the copper or copper alloy side as −ve:
when the thermal conductivity of the copper or copper alloy is 250 W/mK or more, a range of the contact position is from more than 0 mm to +15 mm, and
when the thermal conductivity of the copper or copper alloy is less than 250 W/mK, the range of the contact position is from −15 mm to +15 mm,
a maximum arrival temperature of the stainless steel is 250 °C or lower, and
a residence time of the stainless steel in a temperature range of 100 °C or higher is 5 s or longer to 5 min or shorter.

4. The method of joining stainless steel and copper or copper alloy according to claim 3, wherein the heating device is a soldering iron.

5. A joined body of stainless steel and copper or copper alloy, joined by the method of joining stainless steel and copper or copper alloy according to claim 1.

6. A method of producing a joined body of stainless steel and copper or copper alloy, the method comprising joining stainless steel and copper or copper alloy by the method of joining stainless steel and copper or copper alloy according to claim 1.

7. A joined body of stainless steel and copper or copper alloy, joined by the method of joining stainless steel and copper or copper alloy according to claim 2.

8. A joined body of stainless steel and copper or copper alloy, joined by the method of joining stainless steel and copper or copper alloy according to claim 3.

9. A joined body of stainless steel and copper or copper alloy, joined by the method of joining stainless steel and copper or copper alloy according to claim 4.

10. A method of producing a joined body of stainless steel and copper or copper alloy, the method comprising joining stainless steel and copper or copper alloy by the method of joining stainless steel and copper or copper alloy according to claim 2.

11. A method of producing a joined body of stainless steel and copper or copper alloy, the method comprising joining stainless steel and copper or copper alloy by the method of joining stainless steel and copper or copper alloy according to claim 3.

12. A method of producing a joined body of stainless steel and copper or copper alloy, the method comprising joining stainless steel and copper or copper alloy by the method of joining stainless steel and copper or copper alloy according to claim 4.
